(19) United States
(12) Patent Application Publication
(10) Pub. No.: US 2026/0031006 A1
(43) Pub. Date: Jan. 29, 2026

(54) Display Device and Defect Inspection Method Therefor

(71) Applicant: LG Display Co., Ltd., Seoul (KR)

(72) Inventors: Su Min Cho, Paju-si (KR); Young Jin Kim, Paju-si (KR)

(21) Appl. No.: 19/249,953

(22) Filed: Jun. 25, 2025

(30) Foreign Application Priority Data
Jul. 26, 2024 (KR) 10-2024-0099744

(51) Int. Cl. G09G 3/00; G09G 3/32

(52) U.S. Cl. CPC G09G 3/006; G09G 3/32; G09G 2310/08; G09G 2320/0233; G09G 2320/0247; G09G 2330/025; G09G 2330/12

(57) ABSTRACT

A display device and a defect inspection method are disclosed. The display device includes a substrate including a plurality of first light-emitting regions and a plurality of second light-emitting regions in which a plurality of inorganic light-emitting elements are disposed, a first pixel driving circuit disposed in each of the plurality of first light-emitting regions, and a second pixel driving circuit disposed in each of the plurality of second light-emitting regions, wherein a driving order of horizontal lines in the first light-emitting regions is different from a driving order of horizontal lines in the second light-emitting regions.

### CROSS-REFERENCE TO RELATED APPLICATION

This application claims priority to and the benefit of Republic of Korea Patent Application No. 10-2024-0099744, filed on Jul. 26, 2024, which is hereby incorporated by reference in its entirety.

### BACKGROUND

### 1. Field of Technology

The present specification relates to a display device and a defect inspection method therefor.

### 2. Discussion of Related Art

Display devices are being applied to various electronic devices such as televisions (TVs), mobile phones, laptops, and tablets.

Display devices include organic light-emitting display (OLED) devices, which are self-emissive, liquid crystal display (LCD) devices, which require a separate light source, and the like.

In recent years, display devices including light-emitting diodes (LEDs) have been attracting attention as next-generation display devices. Since LEDs are formed of inorganic materials rather than organic materials, the display devices including LEDs have a fast lighting speed and high luminous efficacy, and can display high-brightness images compared to liquid crystal display devices or organic light-emitting display devices.

### SUMMARY

A flicker phenomenon may occur when driving horizontal lines in a display device using micro light-emitting diodes (micro LEDs).

Embodiments of the present specification are directed to providing a display device in which a flicker phenomenon is improved.

Embodiments of the present specification are also directed to providing a defect inspection method for a display device that enables early detection of defects.

Objectives according to embodiments of the present specification are not limited to the above-described objectives, and other objectives that are not described herein will be apparently understood by those skilled in the art from the following description.

A display device according to an embodiment of the present specification may include a substrate including a plurality of first light-emitting regions and a plurality of second light-emitting regions in which a plurality of inorganic light-emitting elements are disposed, a first pixel driving circuit disposed in each of the plurality of first light-emitting regions, and a second pixel driving circuit disposed in each of the plurality of second light-emitting regions. A driving order of horizontal lines in the first light-emitting regions may be different from a driving order of horizontal lines in the second light-emitting regions.

A defect inspection method according to an embodiment of the present specification may include preparing a display device including a plurality of first light-emitting regions and a plurality of second light-emitting regions in which a plurality of inorganic light-emitting elements are disposed, and driving horizontal lines of the first light-emitting regions and horizontal lines of the second light-emitting regions in different driving orders. The defect inspection method may further include inspecting whether inorganic light-emitting elements in the horizontal lines other than the driven horizontal line emit light, in the first light-emitting regions and the second light-emitting regions.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is an exploded perspective view of a display device according to an embodiment of the present specification;

FIG. 2 is a plan view of the display device according to an embodiment of the present specification;

FIG. 3 is an enlarged view of the display device according to the embodiment of the present specification;

FIG. 4 is a diagram illustrating a pixel driving circuit according to an embodiment of the present specification;

FIG. 5 is a diagram illustrating a pixel driving circuit according to an embodiment of the present specification;

FIG. 6 is a plan view of a display device according to an embodiment of the present specification:

FIG. 7 is a plan view of a first light-emitting region according to the embodiment of the present specification;

FIGS. 8 to 10 are views illustrating driving states of horizontal lines of the first light-emitting region and horizontal lines of a second light-emitting region according to the embodiment of the present specification;

FIG. 11 is a plan view of a display device according to an embodiment of the present specification;

FIG. 12 is a plan view of the display device according to an embodiment of the present specification;

FIG. 13 is a plan view of the display device according to an embodiment of the present specification;

FIGS. 14A and 14B are cross-sectional views of the display device according to an embodiment of the present specification;

FIG. 15 is a cross-sectional view of the display device according to an embodiment of an present specification;

FIG. 16 is a view illustrating a defect detection device for the display device according to an embodiment of the present specification;

FIG. 17 is a view illustrating a state in which a short circuit has occurred on some horizontal lines of the display device according to an embodiment of the present specification;

FIG. 18 is a timing diagram of a first pixel driving circuit according to an embodiment of the present specification;

FIG. 19 is a timing diagram of a second pixel driving circuit according to an embodiment of the present specification;

FIG. 20 is a photograph illustrating a process of inspecting a light emission pattern of a third horizontal line according to an embodiment of the present specification;

FIG. 21 is a view illustrating a state in which a short circuit has occurred between first horizontal lines of the display device according to an embodiment of the present specification;

FIG. 22 is a photograph illustrating a process of inspecting a light emission pattern of the seventh horizontal line according to an embodiment of the present specification; and

FIGS. 23 to 26 are views illustrating devices to which the display device is applied according to embodiments of the present specification.

### DETAILED DESCRIPTION

Advantages and features of the present specification and a method of achieving the same should become clear with embodiments described in detail below with reference to the accompanying drawings. However, the present specification is not limited to the embodiments described below and may be implemented in various different forms. The embodiments are merely provided to allow those skilled in the art to completely understand the scope of the present specification.

The shapes, dimensions, ratios, angles, numbers, and the like disclosed in the drawings for describing the embodiments of the present specification are merely illustrative and are not limited to matters shown in the present specification. Like reference numerals refer to like elements throughout the specification. Further, in describing the present specification, detailed descriptions of well-known technologies will be omitted when it is determined that they may unnecessarily obscure the gist of the present specification. Terms such as “including,” “having,” and “composed of” used herein are intended to allow other elements to be added unless the terms are used with the term “only.” Any references to the singular may include the plural unless expressly stated otherwise.

Components are interpreted as including an ordinary error range even if no such margin is explicitly stated.

In the case of a description of a positional relationship, for example, in the case in which a positional relationship between two portions is described with the terms “on,” “above,” “under,” “next to,” or the like, one or more portions may be interposed therebetween unless the term, for example, “right”, “directly”, or “near” is used in the expression.

For the description of a temporal relationship, when a temporal relationship is described as “after,” “subsequently to,” “next,” “before,” and the like, a non-consecutive case may be included unless the term “immediately” or “directly” is used in the expression.

Although the terms “first,” “second,” and the like may be used herein to describe various components, the components are not limited by the terms. These terms are used only to distinguish one component from another. Therefore, a first component described below may be a second component within the technical scope of the present specification.

Terms such as first, second, A, B, (a), (b), or the like may be used herein when describing components of the present specification. Such terms are used only to distinguish a component from another component, but do not limit the nature, sequence, order, number, or the like of components.

It is to be understood that when a component is described as being “connected,” “coupled,” “linked,” or “attached” to another component, the component may be directly connected, coupled, linked, or attached to the other component, but, unless specifically stated otherwise, still another component may be interposed between the two components so that they are indirectly connected, coupled, linked, or attached.

It is also to be understood that when a component or layer is described as “being in contact with” or “overlapping” another component or layer, the component or layer may be in direct contact with or directly overlapping the other component or layer, but, unless specifically stated otherwise, still another component or layer may be interposed between these two components or layers so that they are in indirect contact with or indirectly overlapping each other.

The term “at least one” should be understood as including any and all combinations of one or more of the associated listed components. For example, the meaning of “at least one of a first component, a second component, and a third component” denotes any combination of two or more of the first component, the second component, and the third component as well as any of the first component, the second component, or the third component.

The terms “first direction,” “second direction,” “third direction,” “X-axis direction,” “Y-axis direction,” and “Z-axis direction” should not be interpreted as referring only to geometrical relationships that are perpendicular to each other, but may indicate a broader range of directions within the functional scope of the configuration described in the present specification.

Features of various embodiments of the present specification may be partially or fully coupled or combined with each other, and technically, various types of interconnection and driving are possible. The embodiments of the present specification may be implemented independently of each other or may be implemented together in a related relationship.

Hereinafter, various embodiments of the present specification will be described in detail with reference to the accompanying drawings.

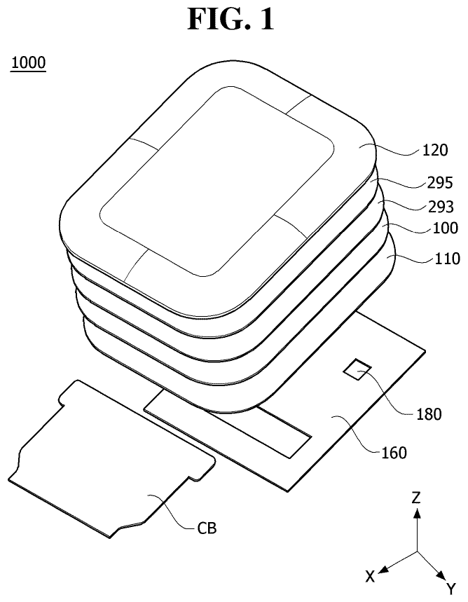

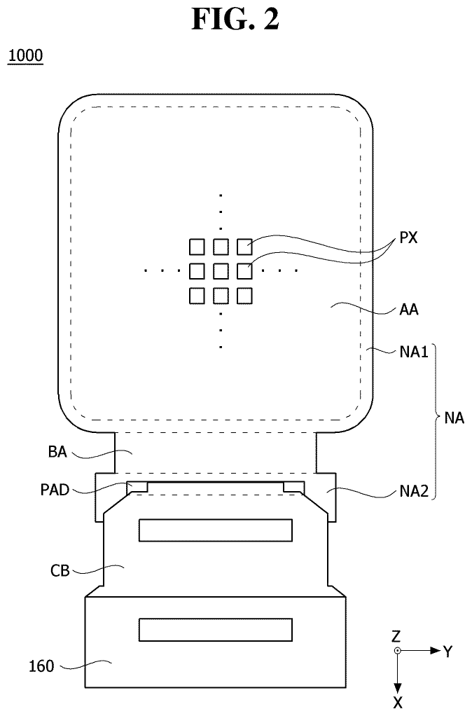

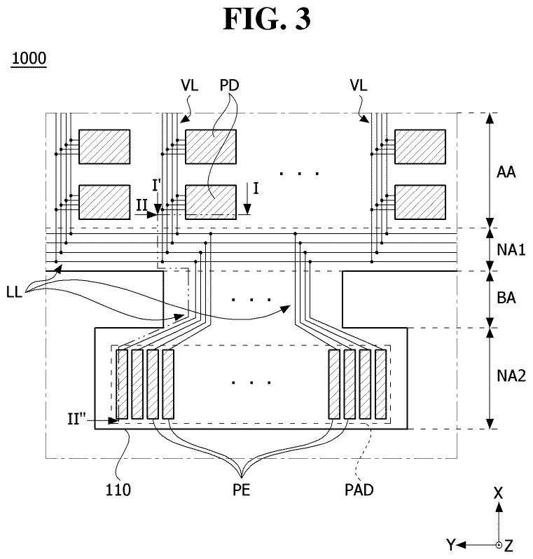

FIG. 1 is an exploded perspective view illustrating a display device according to an embodiment of a present specification. FIG. 2 is a plan view of the display device according to an embodiment of the present specification. FIG. 3 is an enlarged view of the display device according to an embodiment of the present specification.

Referring to FIGS. 1 to 3, a display device 1000 according to an embodiment of the present specification may include a display panel 100, a polarizing layer 293, an adhesive layer 295, a cover member 120, a substrate 110, a flexible circuit board CB, and a printed circuit board 160.

For example, the display device 1000 may include a substrate 110. The substrate 110 may be a member that supports other components of the display device 1000. The substrate 110 may be formed of an insulating material. For example, the substrate 110 may be formed of glass, resin, or the like. In addition, the substrate 110 may be formed of a material that has flexibility. For example, the substrate 110 may be formed of a plastic material having flexibility, such as polyimide (PI). However, the embodiments of the present specification are not limited thereto.

The display panel 100 may implement information, videos, and/or images provided to a user. For example, the display panel 100 may include a display area AA and a non-display area NA. For example, the substrate 110 may include the display area AA and the non-display area NA. The display area AA and the non-display area NA are not limited to the substrate 110 but may be provided throughout the entire display device 1000.

The display area AA may be an area in which an image is displayed. The display area AA may include a plurality of pixels PX. Each of the plurality of pixels PX may be composed of a plurality of sub-pixels. A plurality of light-emitting elements may be disposed in each of the plurality of sub-pixels. The plurality of light-emitting elements may be configured differently depending on the type of the display device 1000. For example, when the display device 1000 is an inorganic light-emitting display device, the light-emitting element may be a light-emitting diode (LED), a micro light-emitting diode (micro LED), or a mini light-emitting diode (mini LED), but the embodiments of the present specification are not limited thereto.

The non-display area NA may be an area in which an image is not displayed. Various lines, circuits, and the like for driving the plurality of pixels PX of the display area AA may be disposed in the non-display area NA. For example, in the non-display area NA, various lines and driving circuits may be mounted, and a pad part PAD to which an integrated circuit, a printed circuit, or the like is connected may be disposed, but the embodiments of the present specification are not limited thereto.

For example, the driving circuits may be data driving circuits and/or gate driving circuits, but the embodiments of the present specification are not limited thereto. Lines through which control signals for controlling the driving circuits are supplied may be disposed on the display panel 100. For example, the control signals may include various timing signals such as clock signals, input data enable signals, and synchronization signals, but the embodiments of the present specification are not limited thereto. The control signals may be received through the pad part PAD. For example, link lines LL for transmitting signals may be disposed in the non-display area NA. For example, driving components such as the flexible circuit board CB and the printed circuit board 160 may be connected to the pad part PAD.

According to the present specification, the non-display area NA may include a first non-display area NA1, a bending area BA, and a second non-display area NA2. For example, the first non-display area NA1 may be an area surrounding at least a portion of the display area AA. The bending area BA may be an area extending from at least one of a plurality of sides of the first non-display area NA1 and may be a bendable area. The second non-display area NA2 may be an area extending from the bending area BA, and the pad part PAD may be disposed therein. For example, the bending area BA may be in a bent state, and the remaining area of the substrate 110, excluding the bending area BA, may be in a flat state. In this case, as the bending area BA is bent, the second non-display area NA2 may be located on a rear surface of the display area AA. However, the embodiments of the present specification are not limited thereto.

The display area AA of the substrate 110 or the display device 1000 may be configured in various shapes depending on the design of the display device 1000. For example, the display area AA may be configured in a rectangular shape with four rounded corners, but the embodiments of the present specification are not limited thereto. In another example, the display area AA may be configured in a rectangular shape with four right-angled corners, a circular shape, or the like, but the embodiments of the present specification are not limited thereto.

According to the present specification, a width of the second non-display area NA2, in which a plurality of pad electrodes PE are disposed, may be greater than a width of the bending area BA, in which the plurality of link lines LL are disposed. In addition, a width of the display area AA in which the plurality of sub-pixels are disposed may be greater than the width of the bending area BA in which the plurality of link lines LL are disposed. In the drawings, the width of the bending area BA is illustrated as being less than that of each of the other areas of the substrate 110, but the shape of the substrate 110 including the bending area BA is exemplary, and the embodiments of the present specification are not limited thereto.

Referring to FIG. 3, a plurality of pixel driving circuits PD may be disposed in the display area AA. The plurality of pixel driving circuits PD may be circuits for driving the light-emitting elements of the plurality of sub-pixels. Each of the plurality of pixel driving circuits PD includes a plurality of transistors, including driving transistors, a storage capacitor, and the like, and the pixel driving circuits PD may supply control signals, power, and driving current to the light-emitting elements of the plurality of sub-pixels, thereby controlling the light-emission operations of the plurality of light-emitting elements. For example, the pixel driving circuit PD may include power lines and signal lines for controlling an on/off state and/or a light-emission time of the light-emitting element. For example, the plurality of pixel driving circuits PD may be driving drivers fabricated using a metal-oxide-semiconductor field-effect transistor (MOSFET) manufacturing process on a semiconductor substrate, but the embodiments of the present specification are not limited thereto.

Referring to FIG. 1 together, the flexible circuit board CB and the printed circuit board 160 may be disposed below the display panel 100. The flexible circuit board CB and the printed circuit board 160 may be disposed on at least one side edge of the display panel 100, but the embodiments of the present specification are not limited thereto. One side of the flexible circuit board CB may be attached to the display panel 100, and the other side thereof may be attached to the printed circuit board 160, but the embodiments of the present specification are not limited thereto. The flexible circuit board CB may be a flexible film, but the embodiments of the present specification are not limited thereto.

The pad part PAD including the plurality of pad electrodes PE may be disposed in the second non-display area NA2. The driving components, including one or more flexible circuit boards (or flexible films) CB and the printed circuit board 160, may be attached or bonded to the pad part PAD. The plurality of pad electrodes PE of the pad part PAD are electrically connected to one or more flexible circuit boards (or flexible films) CB and may transmit various signals (or power) output from the printed circuit board 160 and the flexible circuit boards (or flexible films) CB to the plurality of pixel driving circuits PD in the display area AA.

The flexible circuit board (or flexible film) CB may be a film in which various components are disposed on a base film having flexibility. For example, a driving integrated circuit (IC) such as a gate driver IC or a data driver IC may be disposed on the flexible circuit board (or flexible film) CB, but the embodiments of the present specification are not limited thereto. The driving IC may be a component that processes data and driving signals for displaying images. The driving IC may be disposed using methods such as chip on glass (COG), chip on film (COF), or tape carrier package (TCP) depending on a mounting method, but the embodiments of the present specification are not limited thereto. The flexible circuit board (or flexible film) CB may be attached or bonded onto the plurality of pad electrodes PE through a conductive adhesive layer, but the embodiments of the present specification are not limited thereto.

The printed circuit board 160 may be a component that is electrically connected to one or more flexible circuit boards (or flexible films) CB and supplies signals to the driving IC. The printed circuit board 160 may be disposed on one side of the flexible circuit board (or flexible film) CB and may be electrically connected to the flexible circuit board (or flexible film) CB. Various components for supplying various signals to the driving IC may be disposed on the printed circuit board 160. For example, various components such as a timing controller, a power supply part, a memory, or a processor may be disposed on the printed circuit board 160. For example, the printed circuit board 160 may include a power management integrated circuit (PMIC), but the embodiments of the present specification are not limited thereto.

The printed circuit board 160 may include at least one hole 180, but the embodiments of the present specification are not limited thereto. An internal component configured to detect ambient light or temperature may be disposed in an area corresponding to the at least one hole 180. For example, the internal component may include an ambient light sensor (ALS), a temperature sensor, or the like, but the embodiments of the present specification are not limited thereto. For example, the hole 180 may be a through hole or the like, but the embodiments of the present specification are not limited thereto.

Referring to FIG. 1, the polarizing layer 293 may be disposed on the display panel 100. The polarizing layer 293 may prevent or reduce the light generated from an external light source from entering the display panel 100 and affecting the light-emitting elements or the like.

The cover member 120 may be disposed on the polarizing layer 293. The cover member 120 may be a member for protecting the display panel 100. The adhesive layer 295 may be disposed between the polarizing layer 293 and the cover member 120. The cover member 120 may be attached to the display panel 100 by the adhesive layer 295. The adhesive layer 295 may include an optically clear adhesive (OCA), an optically clear resin (OCR), a pressure-sensitive adhesive (PSA), or the like, but the embodiments of the present specification are not limited thereto.

The substrate 110 may be disposed between the display panel 100 and the printed circuit board 160. The substrate 110 may reinforce the rigidity of the display panel 100. The substrate 110 may be a back plate, but the embodiments of the present specification are not limited thereto.

Referring to FIGS. 1 to 3, a plurality of link lines LL may be disposed in the non-display area NA. The plurality of link lines LL may be lines that transmit various signals supplied from one or more flexible circuit boards (or flexible films) CB and the printed circuit board 160 to the display area AA. The plurality of link lines LL may extend from the plurality of pad electrodes PE in the second non-display area NA2 toward the bending area BA and the first non-display area NA1 and may be electrically connected to a plurality of driving lines VL in the display area AA. The plurality of pixel driving circuits PD may be driven by receiving signals from one or more flexible circuit boards (or flexible films) CB and the printed circuit board 160 through the driving lines VL in the display area AA and the link lines LL in the non-display area NA.

For example, the plurality of driving lines VL, along with the plurality of link lines LL, may serve as lines for transmitting signals output from the flexible circuit board (or flexible film) CB and the printed circuit board 160 to the plurality of pixel driving circuits PD. The plurality of driving lines VL may be disposed in the display area AA and electrically connected to the plurality of pixel driving circuits PD, respectively. The plurality of driving lines VL may extend from the display area AA toward the non-display area NA to be electrically connected to the plurality of link lines LL. Accordingly, the signals output from the flexible circuit board (or flexible film) CB and the printed circuit board 160 may be transmitted to each of the plurality of pixel driving circuits PD through the plurality of link lines LL and the plurality of driving lines VL.

As the bending area BA is bent, some of the plurality of link lines LL may also be bent. Stress may be concentrated on a portion of the bent link lines LL, and as a result, cracks may occur in the link lines LL. Accordingly, the plurality of link lines LL may be formed of a conductive material with excellent flexibility to reduce cracks during the bending of the bending area BA. For example, the plurality of link lines LL may be formed of a conductive material with excellent flexibility such as gold (Au), silver (Ag), or aluminum (Al), but the embodiments of the present specification are not limited thereto. In addition, the plurality of link lines LL may be formed of one of various conductive materials used in the display area AA. For example, the plurality of link lines LL may be formed of molybdenum (Mo), chromium (Cr), titanium (Ti), nickel (Ni), neodymium (Nd), copper (Cu), an alloy of silver (Ag) and magnesium (Mg), or alloys thereof, but the embodiments of the present specification are not limited thereto. The plurality of link lines LL may be configured in a multilayer structure including various conductive materials. For example, the plurality of link lines LL may be configured in a triple-layer structure of titanium (Ti)/aluminum (Al)/titanium (Ti), but the embodiments of the present specification are not limited thereto.

The plurality of link lines LL may be configured in various shapes to reduce stress. At least some of the plurality of link lines LL disposed in the bending area BA may extend in the same direction as an extension direction of the bending area BA or extend in a direction different from the extension direction of the bending area BA to reduce stress. For example, when the bending area BA extends in one direction from the first non-display area NA1 toward the second non-display area NA2, at least some of the link lines LL disposed in the bending area BA may extend in a direction oblique to the one direction. In another example, at least some of the plurality of link lines LL may be configured in various pattern shapes. For example, at least some of the plurality of link lines LL disposed in the bending area BA may have a conductive pattern repetitively disposed in at least one shape among a diamond shape, a rhombus shape, a trapezoidal wave shape, a triangular wave shape, a sawtooth wave shape, a sine wave shape, a circular shape, and an omega (Ω) shape, but the embodiments of the present specification are not limited thereto. Accordingly, to minimize or at least reduce the stress concentrated on the plurality of link lines LL and the resulting cracks, the plurality of link lines LL may be formed in various shapes including the above-described shapes, but the embodiments of the present specification are not limited thereto.

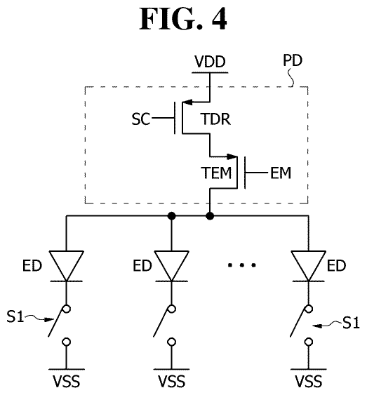

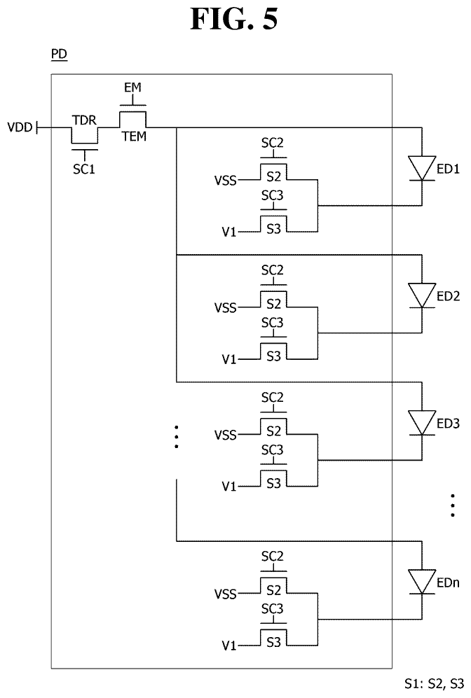

FIG. 4 is a diagram illustrating a pixel driving circuit according to an embodiment of the present specification. FIG. 5 is a diagram illustrating a pixel driving circuit according to an embodiment of the present specification.

Referring to FIG. 4, a pixel driving circuit PD may be connected to a plurality of light-emitting elements ED. For example, eight light-emitting elements ED may be connected to one pixel driving circuit PD. In another example, sixteen light-emitting elements ED may be connected to one pixel driving circuit PD, or thirty-two or sixty-four light-emitting elements ED may be simultaneously connected to one pixel driving circuit PD. The pixel driving circuit PD may be a micro driver (μDriver), but the embodiments of the present specification are not limited thereto. The light-emitting element ED may be a micro light-emitting diode (μLED), but the embodiments of the present specification are not limited thereto.

One pixel driving circuit PD may include a driving transistor TDR, a light-emitting transistor TEM, and switching elements S1, but the embodiments of the present specification are not limited thereto.

For example, the driving transistor TDR has a first electrode to which a high-potential power supply voltage VDD may be applied, a second electrode to which a first electrode of the light-emitting transistor TEM may be connected, and a gate electrode to which a first scan signal SC1 may be applied. The first scan signal SC1 applied to the gate electrode of the driving transistor TDR may be direct current (DC) power, and a fixed reference voltage Vref may be applied for each frame, but the embodiments of the present specification are not limited thereto.

The light-emitting transistor TEM has the first electrode to which the second electrode of the driving transistor TDR may be connected, a second electrode to which the plurality of light-emitting elements ED may be connected, and a gate electrode to which an emission signal EM may be applied. The emission signal EM applied to the gate electrode of the light-emitting transistor TEM may be a pulse width modulation (PWM) signal that varies for each frame, but the embodiments of the present specification are not limited thereto.

The switching elements S1 may apply a low-potential power supply voltage VSS to the plurality of light-emitting elements ED. The switching elements S1 may each include at least one transistor. When the switching elements S1 are turned on, the low-potential power supply voltage VSS may be applied to the plurality of light-emitting elements ED.

A first electrode of each of the plurality of light-emitting elements ED may be connected to the second electrode of the light-emitting transistor TEM, and a second electrode of each of the light-emitting elements ED may be connected to the switching element S1. For example, the first electrode of the light-emitting element ED may be an anode, and the second electrode of the light-emitting element ED may be a cathode, but the embodiments of the present specification are not limited thereto.

The driving transistor TDR, the light-emitting transistor TEM, and the switching elements S1 may each be an n-type transistor or a p-type transistor, but the embodiments of the present specification are not limited thereto.

In the pixel driving circuit PD, the driving transistor TDR may be turned on by the first scan signal SC1 applied from a timing controller, and the light-emitting transistor TEM may be turned on by the emission signal EM. As a result, a driving current may be applied to the light-emitting element ED via the driving transistor TDR and the light-emitting transistor TEM by the high-potential power supply voltage VDD applied to the first electrode of the driving transistor TDR.

In the pixel driving circuit PD, the switching elements S1 may be selectively turned on or off by the scan signal applied from the timing controller. When the switching element S1 is turned on, the low-potential power supply voltage VSS may be applied to the corresponding light-emitting element.

Among the plurality of light-emitting elements ED, only the light-emitting element with the anode to which the high-potential power supply voltage VDD is applied and the cathode to which the low-potential power supply voltage VSS is applied may selectively emit light.

Referring to FIG. 5, a pixel driving circuit PD may include a driving transistor TDR connected to the high-potential power supply voltage VDD, a light-emitting transistor TEM disposed between the driving transistor TDR and one end (or one side) of each of light-emitting elements ED, and switching elements S1 each disposed between the low-potential power supply voltage VSS and the other end (or the other side) of each of the light-emitting elements ED.

When the driving transistor TDR and the light-emitting transistor TEM are turned on, the high-potential power supply voltage VDD may be applied to a plurality of light-emitting elements ED1, ED2, ED3, . . . , and EDn.

The switching elements S1 may each include a first switching transistor S2 that applies the low-potential power supply voltage VSS to the other end of the light-emitting element ED and a second switching transistor S3 that applies an off voltage V1 that is different from or higher than the low-potential power supply voltage VSS to the other end of the light-emitting element ED. The first switching transistor S2 may be turned on when a second scan signal SC2 is applied, and the second switching transistor S3 may be turned on when a third scan signal SC3 is applied. According to the present specification, the off voltage V1 may be a third voltage, but the embodiments of the present specification are not limited thereto.

The off voltage V1 may be set higher than the low-potential power supply voltage VSS. For example, the low-potential power supply voltage VSS may be set to −5 V, and the off voltage V1 may be set to −1 V, but the embodiments of the present specification are not limited thereto. Thus, the light-emitting element ED may emit light when the first switching transistor S2 is turned on, the high-potential power supply voltage VDD is applied, and the low-potential power supply voltage VSS is applied to the light-emitting element ED. However, the light-emitting element ED may not emit light when the second switching transistor S3 is turned on and the off voltage V1 is applied. However, the present specification is not limited thereto, and the switching element S1 may include only the first switching transistor S2. In this case, when the first switching transistor S2 is turned on and the low-potential power supply voltage VSS is applied, the light-emitting element ED may be turned on, and when the first switching transistor S2 is turned off, the light-emitting element ED may be floated and may not emit light.

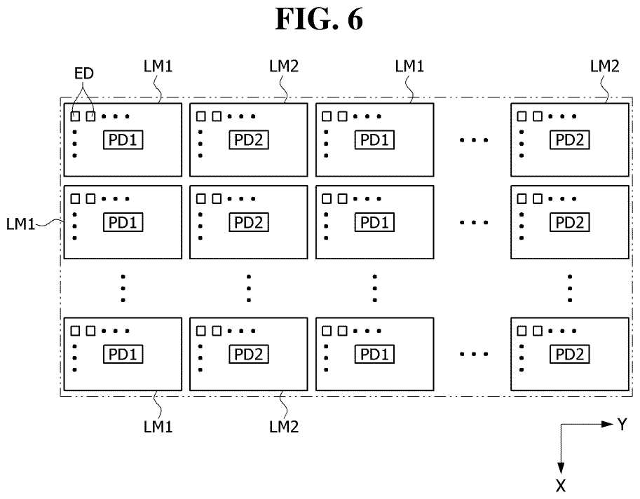

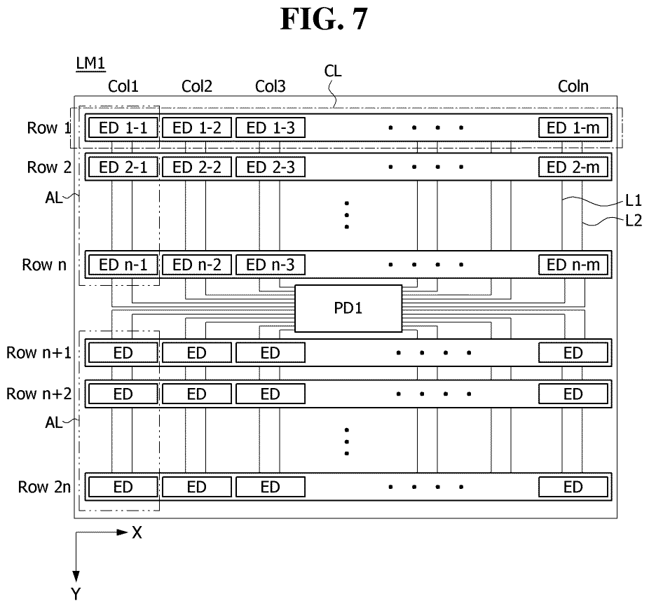

FIG. 6 is a plan view of a display device according to an embodiment of the present specification. FIG. 7 is a plan view of a first light-emitting region according to an embodiment of the present specification.

Referring to FIG. 6, in the display device, a plurality of first light-emitting regions LM1 and a plurality of second light-emitting regions LM2 may be alternately disposed on a substrate. The plurality of first light-emitting regions LM1 and the plurality of second light-emitting regions LM2 may be alternately disposed along a horizontal line. The horizontal line may be parallel to a second direction (Y-axis direction).

The plurality of first light-emitting regions LM1 and the plurality of second light-emitting regions LM2 may have the same area, but the embodiments of the present specification are not limited thereto. For example, among the plurality of first light-emitting regions LM1, the first light-emitting region LM1 disposed at an edge may have a smaller or larger area than the first light-emitting region LM1 disposed at a central portion. When a display area is circular and the light-emitting regions are partitioned in rectangular units, the areas and shapes of the light-emitting regions along a rounded edge may vary.

The plurality of first light-emitting regions LM1 and the plurality of second light-emitting regions LM2 may each include a plurality of light-emitting elements ED, a pixel driving circuit PD, and lines connecting the plurality of light-emitting elements ED and the pixel driving circuit PD.

Each of the plurality of first light-emitting regions LM1 may include the plurality of light-emitting elements ED that are continuously disposed in the second direction (Y-axis direction) and a first direction (X-axis direction). The plurality of light-emitting elements ED may each function as a pixel. A first pixel driving circuit PD1 may be connected to the plurality of light-emitting elements ED and may independently drive the plurality of light-emitting elements ED.

The plurality of second light-emitting regions LM2 may each include the plurality of light-emitting elements ED continuously disposed in the first direction and the second direction. The plurality of light-emitting elements ED may each function as a pixel. A second pixel driving circuit PD2 is connected to the plurality of light-emitting elements ED and may independently drive the plurality of light-emitting elements ED.

Referring to FIG. 7, in the first light-emitting region LM1, the plurality of light-emitting elements ED may be disposed along horizontal lines and vertical lines. The horizontal lines may correspond to rows, and the vertical lines may correspond to columns. The plurality of light-emitting elements ED may be disposed on each of the horizontal lines from a first horizontal line to a 2n-th horizontal line. The horizontal lines may be parallel to the second direction (Y-axis direction), and the vertical lines may be parallel to the first direction (X-axis direction).

The first pixel driving circuit PD1 may apply a second voltage to a plurality of inorganic light-emitting elements disposed along the horizontal lines and apply a first voltage to a plurality of inorganic light-emitting elements disposed along the vertical lines. The first voltage may be a high-potential power supply voltage, and the second voltage may be a low-potential power supply voltage, but the embodiments of the present specification are not limited thereto.

A second electrode may be disposed for each horizontal line, and a plurality of second voltage application regions CL may be partitioned accordingly. The plurality of second voltage application regions CL respectively disposed on the horizontal lines may be electrically insulated from each other. When the low-potential power supply voltage is applied to an n-th second electrode by the first pixel driving circuit PD1, the low-potential power supply voltage may be commonly applied to the light-emitting elements ED disposed on an n-th horizontal line.

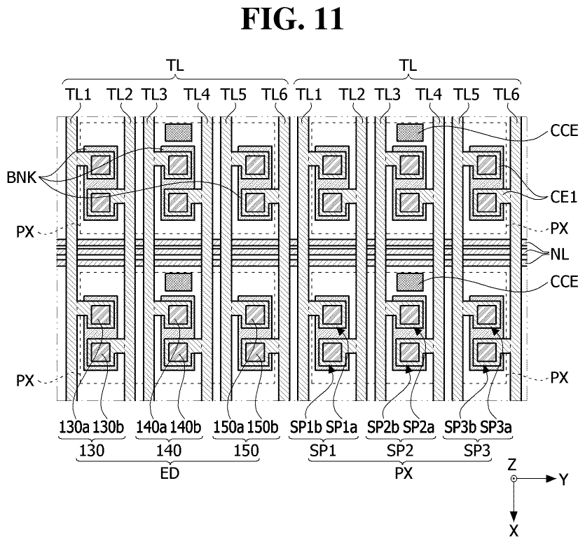

A plurality of first electrodes CE1 (see FIG. 11), on which the plurality of light-emitting elements ED are disposed, may be connected to signal lines TL (see FIG. 11) extending along the vertical lines. Accordingly, first voltage application regions AL may be partitioned in units of vertical lines within a light-emitting region. When the high-potential power supply voltage VDD is applied to a first vertical line Col1, the high-potential power supply voltage VDD may be commonly applied to the light-emitting elements ED disposed in the first voltage application region AL.

According to the embodiment, the first pixel driving circuit PD1 may drive the plurality of light-emitting elements ED disposed in the first light-emitting region LM1 on a horizontal line basis. The first pixel driving circuit PD1 may apply the low-potential power supply voltage VSS to the horizontal line to be driven and then apply the high-potential power supply voltage VDD sequentially for each vertical line while switching between the first voltage application regions AL.

For example, in order to emit light from a first horizontal line Row 1, the first pixel driving circuit PD1 may apply the low-potential power supply voltage VSS to the first horizontal line Row 1 and apply the high-potential power supply voltage VDD to the first vertical line Col1. Accordingly, since the high-potential power supply voltage VDD and the low-potential power supply voltage VSS are simultaneously applied to only a 1-1 light-emitting element ED 1-1, only the 1-1 light-emitting element ED 1-1 may emit light.

For example, the first pixel driving circuit PD1 may apply the low-potential power supply voltage VSS to the first horizontal line Row 1 and apply the high-potential power supply voltage VDD to a second vertical line Col2. Thus, a 1-2 light-emitting elements ED 1-2 to which the high-potential power supply voltage VDD and the low-potential power supply voltage VSS are simultaneously applied may emit light. According to the embodiment, light may be emitted from one horizontal line by sequentially applying the high-potential power supply voltage VDD to the vertical lines during one horizontal period. The second pixel driving circuit PD2 may also be driven in the same manner. Driving (or emitting light from) the horizontal line may refer to line-by-line driving (or emission) by causing the plurality of light-emitting elements disposed on the corresponding horizontal line to emit light, but the embodiments of the present specification are not limited thereto.

The second voltage application region CL may be disposed for each horizontal line. The first voltage application regions AL may include a region disposed above and a region disposed below the first pixel driving circuit PD1. However, the embodiments of the present specification are not limited thereto. For example, in the first voltage application region AL, the high-potential power supply voltage VDD may be applied to the light-emitting elements disposed on each vertical line.

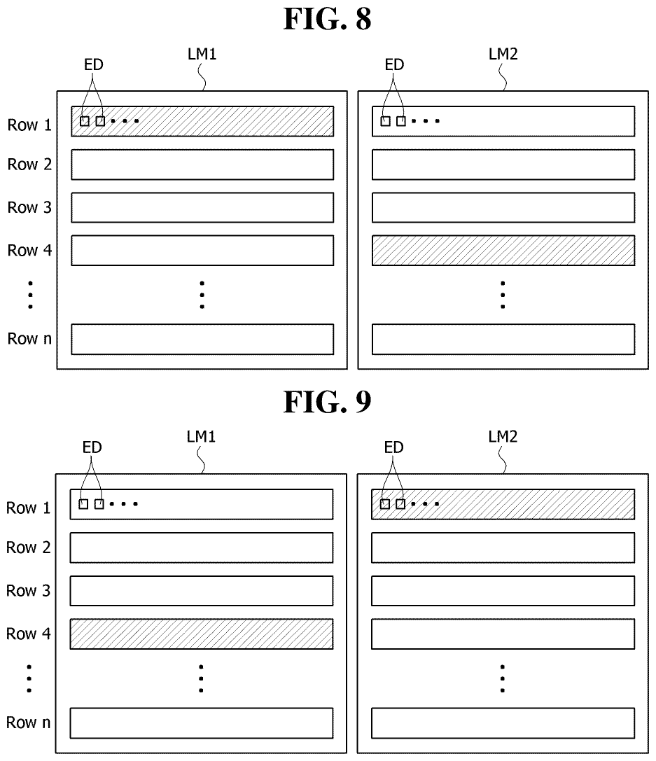

FIGS. 8 to 10 are views illustrating driving states of the horizontal lines of the first light-emitting region and the horizontal lines of the second light-emitting region according to the embodiment of the present specification.

Referring to FIGS. 8 to 10, the first light-emitting region LM1 and the second light-emitting region LM2 may be controlled such that driving orders of all the horizontal lines are different. Since the driving orders are different, the horizontal line in the first light-emitting region LM1 and the horizontal line in the second light-emitting region LM2, which correspond to the same line number, may be driven in different horizontal periods, and thus light may not be emitted simultaneously from the horizontal line in the first light-emitting region LM1 and the horizontal line in the second light-emitting region LM2, which correspond to the same line number.

For example, the horizontal lines of the plurality of first light-emitting regions LM1 may be driven in an order such as 1st, 4th, . . . , and n-th, while the horizontal lines of the plurality of second light-emitting regions LM2 may be driven in an order such as 4th, 1st, . . . , and 2nd. The plurality of light-emitting elements ED disposed on each horizontal line may emit light sequentially. However, the embodiments of the present specification are not limited thereto. For example, the plurality of light-emitting elements ED disposed on the horizontal line may emit light simultaneously.

The horizontal lines of each of the plurality of first light-emitting regions LM1 may have the same driving order, and the horizontal lines of each of the plurality of second light-emitting regions LM2 may also have the same driving order. However, the embodiments of the present specification are not limited thereto. For example, the horizontal lines in the plurality of first light-emitting regions LM1 may have different driving orders. For example, the plurality of light-emitting regions may include first to n-th light-emitting regions, and the driving orders of the first to n-th light-emitting regions may be configured to be different.

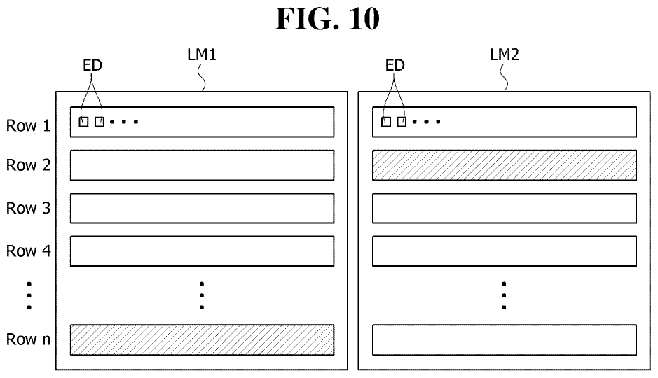

Referring to FIG. 8, when the light-emitting elements ED on the first horizontal line Row 1 of the first light-emitting region LM1 are driven, the light-emitting elements ED on a fourth horizontal line Row 4 of the second light-emitting region LM2 may be driven. Referring to FIG. 9, when the light-emitting elements ED on the fourth horizontal line Row 4 of the first light-emitting region LM1 are driven, the light-emitting elements ED on the first horizontal line Row 1 of the second light-emitting region LM2 may be driven. Referring to FIG. 10, when the light-emitting elements ED on an n-th horizontal line Row n of the first light-emitting region LM1 are driven, the light-emitting elements ED on a second horizontal line Row 2 of the second light-emitting region LM2 may be driven.

According to the present specification, the first light-emitting region LM1 and the second light-emitting region LM2 may be configured such that the driving orders of all the horizontal lines are different. Accordingly, for example, when the light-emitting elements ED on the first horizontal line Row 1 of the first light-emitting region LM1 are driven, the light-emitting elements ED on the first horizontal line Row 1 of the second light-emitting region LM2 may not be driven at the same time. For example, when the light-emitting elements ED on the fourth horizontal line Row 4 of the first light-emitting region LM1 are driven, the light-emitting elements ED on the fourth horizontal line Row 4 of the second light-emitting region LM2 may not be driven at the same time.

In a display device including micro light-emitting elements ED, the light-emitting elements ED are each very small in size, and thus, when the pixel driving circuit PD sequentially drives the horizontal lines in the light-emitting region from top to bottom, a horizontal flicker phenomenon may occur. According to the present specification, the first light-emitting region LM1 and the second light-emitting region LM2 perform shuffling driving in which the horizontal lines are driven according to a non-sequential driving order, thereby improving a flicker phenomenon, such as, a horizontal flicker phenomenon. In addition, since light is not emitted simultaneously from the horizontal line in the first light-emitting region LM1 and the horizontal line the second light-emitting region LM2, which correspond to the same line number and are disposed adjacent to each other along the horizontal line in the display area, a flicker phenomenon, e.g., a horizontal flicker phenomenon, may be further improved.

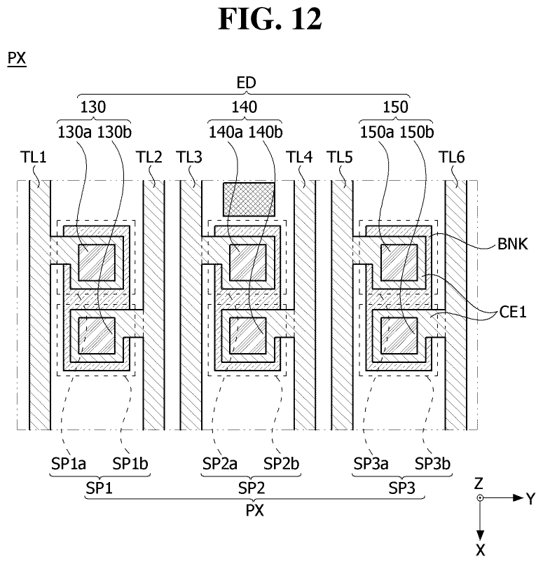

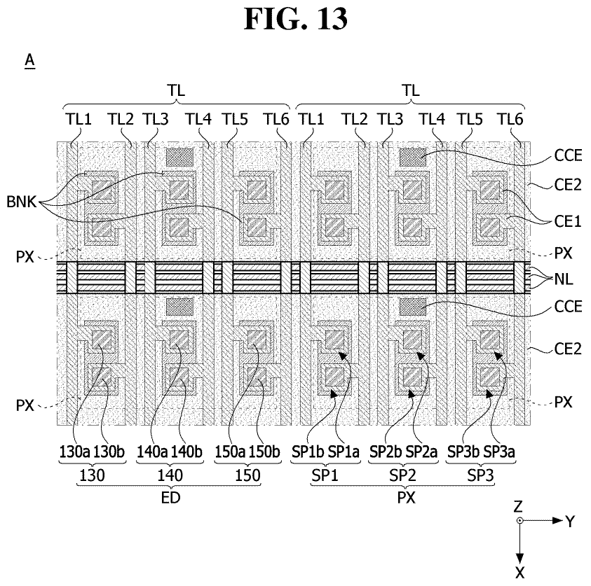

FIGS. 11 to 13 are plan views of a display device according to an embodiment of the present specification. For example, FIG. 11 is an enlarged plan view of a display area including a plurality of pixels. For example, FIG. 12 is an enlarged plan view of the display area including one pixel. For example, FIG. 13 is an enlarged plan view of the display area including the plurality of pixels. FIGS. 11 and 12 illustrate a plurality of signal lines TL, a plurality of communication lines NL, a plurality of first electrodes CE1, a plurality of banks BNK, and a plurality of light-emitting elements ED, but the embodiments of the present specification are not limited thereto. FIG. 13 is an enlarged plan view of FIG. 11, in which a plurality of second electrodes CE2 are additionally disposed.

Referring to FIGS. 11 and 12, a plurality of pixels PX, each composed of a plurality of sub-pixels, may be disposed in the display area AA. Each of the plurality of sub-pixels includes a light-emitting element ED and may emit light independently. The plurality of sub-pixels may be disposed in a matrix form forming a plurality of rows and a plurality of columns, but the embodiments of the present specification are not limited thereto.

The plurality of sub-pixels may include a first sub-pixel SP1, a second sub-pixel SP2, and a third sub-pixel SP3. For example, one of the first sub-pixel SP1, the second sub-pixel SP2, and the third sub-pixel SP3 may be a red sub-pixel, another one thereof may be a green sub-pixel, and the remaining one thereof may be a blue sub-pixel. The types of the plurality of sub-pixels are exemplary, and the embodiments of the present specification are not limited thereto.

Each of the plurality of pixels PX may include one or more first sub-pixels SP1, one or more second sub-pixels SP2, and one or more third sub-pixels SP3. For example, one pixel PX may include a pair of first sub-pixels SP1, a pair of second sub-pixels SP2, and a pair of third sub-pixels SP3. The pair of first sub-pixels SP1 may be composed of a 1-1 sub-pixel SP1a and a 1-2 sub-pixel SP1b. The pair of second sub-pixels SP2 may be composed of a 2-1 sub-pixel SP2a and a 2-2 sub-pixel SP2b. The pair of third sub-pixels SP3 may be composed of a 3-1 sub-pixel SP3a and a 3-2 sub-pixel SP3b. For example, one pixel PX may include the 1-1 sub-pixel SP1a and the 1-2 sub-pixel SP1b, the 2-1 sub-pixel SP2a and the 2-2 sub-pixel SP2b, and the 3-1 sub-pixel SP3a and the 3-2 sub-pixel SP3b, but the embodiments of the present specification are not limited thereto.

The plurality of sub-pixels constituting one pixel PX may be arranged in various ways. For example, in one pixel PX, the pair of first sub-pixels SP1 may be disposed in the same column, the pair of second sub-pixels SP2 may be disposed in the same column, and the pair of third sub-pixels SP3 may be disposed in the same column. The first sub-pixel SP1, the second sub-pixel SP2, and the third sub-pixel SP3 may be disposed in the same row. The number and arrangement of the plurality of sub-pixels constituting one pixel PX are exemplary, and the embodiments of the present specification are not limited thereto.

A plurality of signal lines TL may be disposed in areas between the plurality of sub-pixels. The plurality of signal lines TL may extend in a column direction between the plurality of sub-pixels. The plurality of signal lines TL may be lines that transmit an anode voltage output from the pixel driving circuit PD to the plurality of sub-pixels. For example, the plurality of signal lines TL may be electrically connected to the plurality of pixel driving circuits PD and the first electrodes CE1 of the plurality of sub-pixels. The anode voltage output from the pixel driving circuit PD may be transmitted to the first electrodes CE1 of the plurality of sub-pixels through the plurality of signal lines TL. For example, the first electrode CE1 may be an electrode that is electrically connected to an anode 134 of the light-emitting element ED. Thus, the anode voltage transmitted through the signal line TL may be transmitted to the anode 134 of the light-emitting element ED through the first electrode CE1.

Accordingly, the structure of the display device 1000 may be simplified by using the pixel driving circuit PD, in which a plurality of pixel circuits are integrated, instead of forming a plurality of transistors and a storage capacitor in each of the plurality of sub-pixels. In addition, as the circuits disposed in each of the plurality of sub-pixels are integrated into one pixel driving circuit PD, high-efficiency and low-power operation may be enabled.

The plurality of signal lines TL may include a first signal line TL1, a second signal line TL2, a third signal line TL3, a fourth signal line TL4, a fifth signal line TL5, and a sixth signal line TL6. The first signal line TL1 and the second signal line TL2 may be electrically connected to the pair of first sub-pixels SP1, respectively. The third signal line TL3 and the fourth signal line TL4 may be electrically connected to the pair of second sub-pixels SP2, respectively. The fifth signal line TL5 and the sixth signal line TL6 may be electrically connected to the pair of third sub-pixels SP3, respectively.

The first signal line TL1 may be disposed on one side of the pair of first sub-pixels SP1, and the second signal line TL2 may be disposed on another side of the pair of first sub-pixels SP1. The first signal line TL1 may be electrically connected to the first electrode CE1 of one of the pair of first sub-pixels SP1, for example, the 1-1 sub-pixel SP1a. The second signal line TL2 may be electrically connected to the first electrode CE1 of the other of the pair of first sub-pixels SP1, for example, the 1-2 sub-pixel SP1b.

The third signal line TL3 may be disposed on one side of the pair of second sub-pixels SP2, and the fourth signal line TL4 may be disposed on another side of the pair of second sub-pixels SP2. For example, the third signal line TL3 may be disposed adjacent to the second signal line TL2. The third signal line TL3 may be electrically connected to the first electrode CE1 of one of the pair of second sub-pixels SP2, for example, the 2-1 sub-pixel SP2a. The fourth signal line TL4 may be electrically connected to the first electrode CE1 of the other of the pair of second sub-pixels SP2, for example, the 2-2 sub-pixel SP2b.

The fifth signal line TL5 may be disposed on one side of the pair of third sub-pixels SP3, and the sixth signal line TL6 may be disposed on another side of the pair of third sub-pixels SP3. For example, the fifth signal line TL5 may be disposed adjacent to the fourth signal line TL4. The sixth signal line TL6 may be disposed adjacent to the first signal line TL1 connected to the neighboring pixel PX. The fifth signal line TL5 may be electrically connected to the first electrode CE1 of one of the pair of third sub-pixels SP3, for example, the 3-1 sub-pixel SP3a. The sixth signal line TL6 may be electrically connected to the first electrode CE1 of the other of the pair of third sub-pixels SP3, for example, the 3-2 sub-pixel SP3b.

The plurality of signal lines TL may be formed of a conductive material. For example, the plurality of signal lines TL may be formed of a conductive material such as titanium (Ti), aluminum (Al), copper (Cu), molybdenum (Mo), nickel (Ni), chromium (Cr), indium tin oxide (ITO), indium zinc oxide (IZO), or indium gallium zinc oxide (IGZO), but the embodiments of the present specification are not limited thereto. In another example, the plurality of signal lines TL may be formed in a multilayer structure of conductive materials. For example, the plurality of signal lines TL may be formed in a multilayer structure of titanium (Ti)/aluminum (Al)/titanium (Ti)/indium tin oxide (ITO), but the embodiments of the present specification are not limited thereto.

The plurality of communication lines NL may be disposed in areas between the plurality of pixels PX. The plurality of communication lines NL may be disposed to extend in a row direction in the areas between the plurality of pixels PX. The plurality of communication lines NL are disposed in areas between the plurality of second electrodes CE2 and may not overlap the plurality of second electrodes CE2. For example, the plurality of communication lines NL may be lines used for short circuit-range communication, such as near-field communication (NFC).

The plurality of communication lines NL may function as antennas. For example, the plurality of communication lines NL may be a plurality of connection lines or the like, but the embodiments of the present specification are not limited thereto.

According to the present specification, a bank BNK may be disposed in each of the plurality of sub-pixels. The plurality of banks BNK may be structures on which the plurality of light-emitting elements ED are mounted. The plurality of banks BNK may guide the positions of the plurality of light-emitting elements ED in a transfer process of transferring the plurality of light-emitting elements ED to the display device 1000. In the transfer process of the plurality of light-emitting elements ED, the plurality of light-emitting elements ED may be transferred onto the plurality of banks BNK. The plurality of banks BNKs may be bank patterns or structures, but the embodiments of the present specification are not limited thereto.

A bank BNK of the first sub-pixel SP1, a bank BNK of the second sub-pixel SP2, and a bank BNK of the third sub-pixel SP3 may be disposed to be spaced apart from each other. The bank BNK of the first sub-pixel SP1, the bank BNK of the second sub-pixel SP2, and the bank BNK of the third sub-pixel SP3 may be configured to be separated from each other. Thus, the banks BNK of the first sub-pixel SP1, the second sub-pixel SP2, and the third sub-pixel SP3, onto which different types of light-emitting elements ED are transferred, may be easily identified.

A bank BNK of the 1-1 sub-pixel SP1a and a bank BNK of the 1-2 sub-pixel SP1b may be connected to each other or may be spaced apart from each other or separately formed. For example, considering the design requirements of the transfer process and the like, the bank BNK of the 1-1 sub-pixel SP1a and the bank BNK of the 1-2 sub-pixel SP1b, in which the same type of light-emitting elements ED are disposed, may be connected to each other, or may be spaced apart or separated from each other. In addition, a bank BNK of the 2-1 sub-pixel SP2a and a bank BNK of the 2-2 sub-pixel SP2b may be connected to each other or may be spaced apart from each other or separately formed. A bank BNK of the 3-1 sub-pixel SP3a and a bank BNK of the 3-2 sub-pixel SP3b may be connected to each other or may be spaced apart from each other or separately formed. Accordingly, the banks BNK of the pair of first sub-pixels SP1, the banks BNK of the pair of second sub-pixels SP2, and the banks BNK of the pair of third sub-pixels SP3 may be variously formed, but the embodiments of the present specification are not limited thereto.

For example, the plurality of banks BNK may be formed of an organic insulating material. The plurality of banks BNK may be formed of a single layer or multiple layers of an organic insulating material. For example, the plurality of banks BNK may be formed of a photoresist, a polyimide (PI)-based material, a photo acrylic-based material, or the like, but the embodiments of the present specification are not limited thereto.

The first electrode CE1 may be disposed in each of the plurality of sub-pixels. The first electrode CE1 may be disposed on the bank BNK. The first electrode CE1 may be electrically connected to one of the plurality of signal lines TL. At least a portion of the first electrode CE1 may extend outward from the bank BNK to be electrically connected to the signal line TL closest to the first electrode CE1. For example, a portion of the first electrode CE1 of the 1-1 sub-pixel SP1a may extend to one side area of the 1-1 sub-pixel SP1a to be electrically connected to the first signal line TL1, and a portion of the first electrode CE1 of the 1-2 sub-pixel SP1b may extend to the other side area of the 1-2 sub-pixel SP1b to be electrically connected to the second signal line TL2. A portion of the first electrode CE1 of the 2-1 sub-pixel SP2a may extend to one side area of the 2-1 sub-pixel SP2a to be electrically connected to the third signal line TL3, and a portion of the first electrode CE1 of the 2-2 sub-pixel SP2b may extend to the other side area of the 2-2 sub-pixel SP2b to be electrically connected to the fourth signal line TL4. A portion of the first electrode CE1 of the 3-1 sub-pixel SP3a may extend to one side area of the 3-1 sub-pixel SP3a to be electrically connected to the fifth signal line TL5, and a portion of the first electrode CE1 of the 3-2 sub-pixel SP3b may extend to the other side area of the 3-2 sub-pixel SP3b to be electrically connected to the sixth signal line TL6.

The first electrode CE1 may be electrically connected to the anode 134 of the light-emitting element ED and may transmit the anode voltage output from the pixel driving circuit PD to the light-emitting element ED through the signal line TL. Different voltages may be applied to the first electrode CE1 of each of the plurality of sub-pixels depending on the displayed image. For example, different voltages may be applied to the first electrode CE1 of each of the plurality of sub-pixels. Accordingly, the first electrode CE1 may be a pixel electrode, but the embodiments of the present specification are not limited thereto.

The first electrode CE1 may be formed of a conductive material. For example, the first electrodes CE1 may be configured integrally with the plurality of signal lines TL. For example, the first electrodes CE1 may be formed of the same conductive material as the plurality of signal lines TL, but the embodiments of the present specification are not limited thereto. For example, the first electrode CE1 may be formed of a conductive material such as titanium (Ti), aluminum (Al), copper (Cu), molybdenum (Mo), nickel (Ni), chromium (Cr), indium tin oxide (ITO), indium zinc oxide (IZO), or indium gallium zinc oxide (IGZO), but the embodiments of the present specification are not limited thereto. In another example, the first electrode CE1 may be formed in a multilayer structure of conductive materials. For example, the plurality of first electrodes CE1 may be formed in a multilayer structure of titanium (Ti)/aluminum (Al)/titanium (Ti)/indium tin oxide (ITO), but the embodiments of the present specification are not limited thereto.

The light-emitting element ED may be disposed in each of the plurality of sub-pixels. Each of the plurality of light-emitting elements ED may be either a light-emitting diode (LED) or a micro light-emitting diode (micro LED), but the embodiments of the present specification are not limited thereto. The plurality of light-emitting elements ED may be disposed on the banks BNK and the first electrodes CE1. The plurality of light-emitting elements ED may be disposed on the first electrodes CE1 and may be electrically connected to the first electrodes CE1. Thus, the light-emitting element ED may emit light by receiving the anode voltage from the pixel driving circuit PD through the signal line TL and the first electrode CE1.

The plurality of light-emitting elements ED may include a first light-emitting element 130, a second light-emitting element 140, and a third light-emitting element 150. The first light-emitting element 130 may be disposed in the first sub-pixel SP1. The second light-emitting element 140 may be disposed in the second sub-pixel SP2. The third light-emitting element 150 may be disposed in the third sub-pixel SP3. For example, one of the first light-emitting element 130, the second light-emitting element 140, and the third light-emitting element 150 may be a red light-emitting element, another one thereof may be a green light-emitting element, and the remaining one thereof may be a blue light-emitting element, but the embodiments of the present specification are not limited thereto. Accordingly, by combining red light, green light, and blue light emitted from the plurality of light-emitting elements ED, various colors of light including white may be implemented. The types of the plurality of light-emitting elements ED are exemplary, and the embodiments of the present specification are not limited thereto.

The first light-emitting element 130 may include a 1-1 light-emitting element 130a disposed in the 1-1 sub-pixel SP1a and a 1-2 light-emitting element 130b disposed in the 1-2 sub-pixel SP1b. The second light-emitting element 140 may include a 2-1 light-emitting element 140a disposed in the 2-1 sub-pixel SP2a and a 2-2 light-emitting element 140b disposed in the 2-2 sub-pixel SP2b. The third light-emitting element 150 may include a 3-1 light-emitting element 150a disposed in the 3-1 sub-pixel SP3a and a 3-2 light-emitting element 150b disposed in the 3-2 sub-pixel SP3b.

Referring to FIGS. 11 and 12 together with FIG. 13, the second electrode CE2 may be disposed in each of the plurality of sub-pixels. The plurality of second electrodes CE2 may be separated from each other and electrically insulated. The second electrode CE2 may be disposed on the light-emitting element ED. The second electrodes CE2 may be electrically connected to the pixel driving circuit PD through a plurality of contact electrodes CCE.

For example, the second electrode CE2 may be electrically connected to a cathode 135 of the light-emitting element ED, and may transmit a cathode voltage output from the pixel driving circuit PD to the light-emitting element ED. The same cathode voltage may be applied to the second electrode CE2 of each of the plurality of sub-pixels. For example, the same voltage may be applied to the second electrodes CE2 of the plurality of sub-pixels and the cathode 135 of the light-emitting element ED. Accordingly, the second electrode CE2 may be a common electrode, but the embodiments of the present specification are not limited thereto.

At least some of the plurality of sub-pixels may share the second electrode CE2. At least some of the second electrodes CE2 of the plurality of sub-pixels may be electrically connected to each other. Since the same voltage is applied to the second electrodes CE2, the second electrodes CE2 of at least some of the sub-pixels may be shared. For example, the second electrodes CE2 of at least some of the plurality of pixels PX disposed in the same row may be connected to each other. For example, one second electrode CE2 may be disposed in the plurality of pixels PX. One second electrode CE2 may be disposed for every n sub-pixels.

For example, some of the second electrodes CE2 of the plurality of sub-pixels may be spaced apart from each other or separately disposed. For example, the second electrodes CE2 connected to the pixels PX in an n-th row and the second electrodes CE2 connected to the pixels PX in a (n+1)th row may be spaced apart from each other or separately disposed. For example, the plurality of second electrodes CE2 may be disposed to be spaced apart from each other with the plurality of communication lines NL extending in the row direction interposed therebetween. Accordingly, the number of sub-pixels may be greater than the number of second electrodes CE2. In another example, all of the second electrodes CE2 of the plurality of sub-pixels may be interconnected so that only one second electrode CE2 is disposed on the substrate 110, but the embodiments of the present specification are not limited thereto.

The plurality of second electrodes CE2 may be formed of a transparent conductive material, but the embodiments of the present specification are not limited thereto. The plurality of second electrodes CE2 may be formed of a transparent conductive material so that light emitted from the light-emitting elements ED is directed upward through the second electrodes CE2. For example, the second electrode CE2 may be formed of a transparent conductive material such as indium tin oxide (ITO), indium zinc oxide (IZO), or indium gallium zinc oxide (IGZO), but the embodiments of the present specification are not limited thereto.

A plurality of contact electrodes CCE may be disposed on the substrate 110. For example, the plurality of contact electrodes CCE may be disposed to be spaced apart from the plurality of banks BNK and the plurality of signal lines TL. Each of the plurality of second electrodes CE2 may overlap at least one contact electrode CCE. For example, one second electrode CE2 may overlap the plurality of contact electrodes CCE.

For example, the plurality of contact electrodes CCE may be electrically connected to the plurality of second electrodes CE2. The plurality of contact electrodes CCE may be disposed between the substrate 110 and the plurality of second electrodes CE2 and may transmit the cathode voltage output from the pixel driving circuit PD to the second electrodes CE2.

For example, when micro LEDs are used as the light-emitting elements ED, a plurality of micro LEDs may be formed on a wafer and transferred onto the substrate 110 of the display device 1000 to manufacture the display device 1000. During the process of transferring the plurality of light-emitting elements ED having a micro size from the wafer to the substrate 110, various defects may occur. For example, in some sub-pixels, a transfer defect in which the light-emitting element ED is not transferred may occur, and in other sub-pixels, a defect in which the light-emitting element ED is transferred out of an intended position due to misalignment may occur. In addition, although the transfer process proceeds normally, the transferred light-emitting element ED itself may be defective. Thus, in consideration of the defects that may occur during the transfer process of the plurality of light-emitting elements ED, the plurality of light-emitting elements ED of the same type may be transferred onto one sub-pixel. A lighting test may be performed on the plurality of light-emitting elements ED, and ultimately, only one light-emitting element ED that is determined to be normal may be used.

For example, the 1-1 light-emitting element 130a and the 1-2 light-emitting element 130b may be transferred together onto one pixel PX and may be inspected to determine whether there is a defect. When both the 1-1 light-emitting element 130a and the 1-2 light-emitting element 130b are determined to be normal, the 1-1 light-emitting element 130a may be used and the 1-2 light-emitting element 130b may not be used. In another example, when the 1-2 light-emitting element 130b among the 1-1 light-emitting element 130a and the 1-2 light-emitting element 130b is determined to be normal, the 1-1 light-emitting element 130a may not be used and the 1-2 light-emitting element 130b may be used. Accordingly, even when the plurality of light-emitting elements ED of the same type are transferred onto one pixel PX, ultimately, only one light-emitting element ED may be used.

Thus, one of the pair of light-emitting elements ED may be a main (or primary) light-emitting element ED, and the other one thereof may be a redundancy light-emitting element ED. The redundancy light-emitting element ED may serve as a spare light-emitting element when the main light-emitting element ED is defective. In the event of a defective main light-emitting element ED, the redundancy light-emitting element ED may be used as a replacement. Accordingly, by transferring both the main light-emitting element ED and the redundancy light-emitting element ED onto one pixel PX, the degradation of display quality due to the failure of the main light-emitting element ED or the redundancy light-emitting element ED may be minimized.

For example, the 1-1 light-emitting element 130a, the 2-1 light-emitting element 140a, and the 3-1 light-emitting element 150a transferred onto one pixel PX may be used as main light-emitting elements ED, and the 1-2 light-emitting element 130b, the 2-2 light-emitting element 140b, and the 3-2 light-emitting element 150b transferred onto one pixel PX may be used as redundancy light-emitting elements ED.

The display panel 100 according to the present specification may include the first electrodes CE1 disposed below the light-emitting elements ED and may improve light extraction efficiency by exposing a portion of a conductive layer having high reflectivity among a plurality of conductive layers disposed on the first electrodes CE1 through a process such as an etching process.

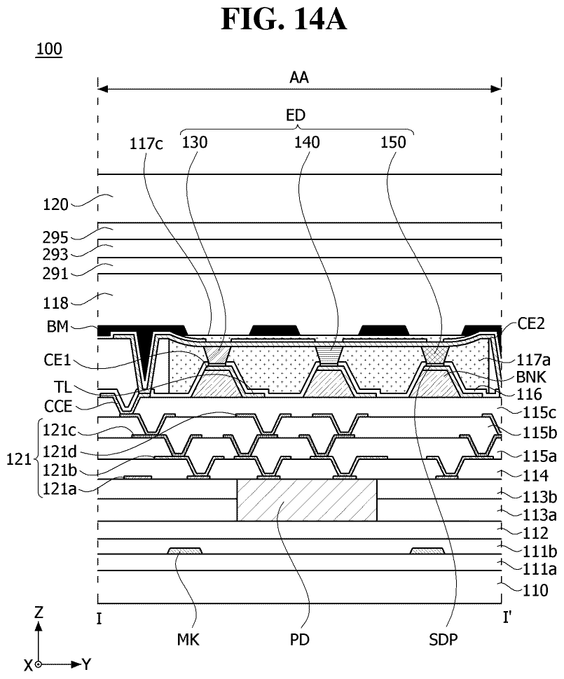

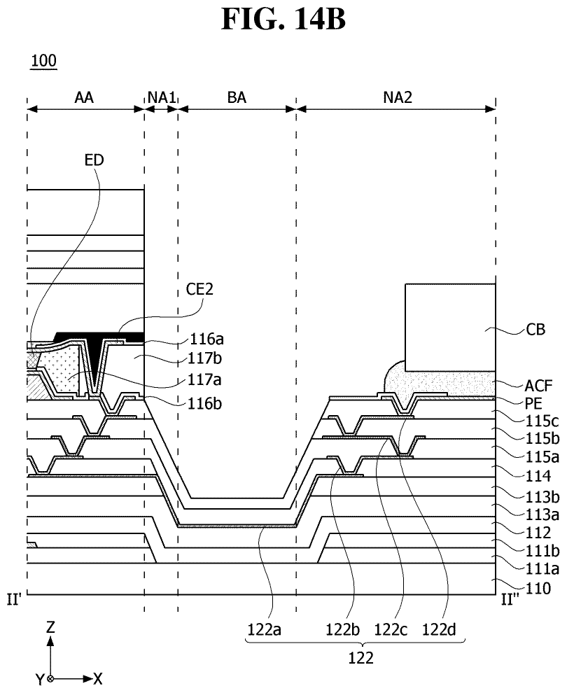

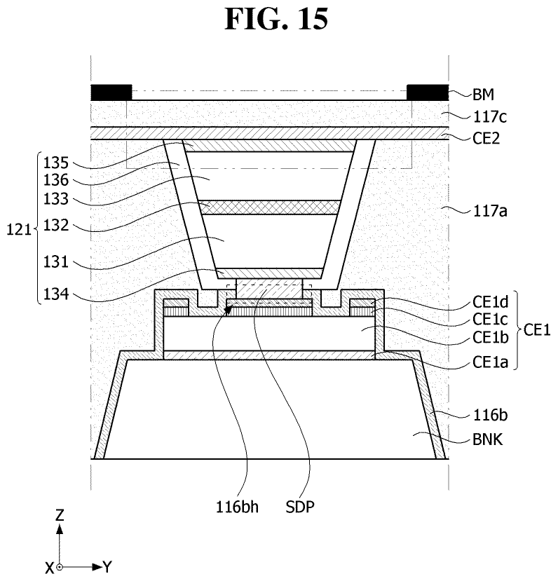

FIGS. 14A and 14B are cross-sectional views of the display device according to an embodiment of the present specification. For example, FIG. 14A is a cross-sectional view of the display area AA taken along line I-I′ of FIG. 3 and FIG. 14B is a cross-sectional view of the first non-display area NA1, the bending area BA, and the second non-display area NA2 taken along line II-II′ of FIG. 3. FIG. 15 is a cross-sectional view of the display device according to an embodiment of the present specification. For example, FIG. 15 is a cross-sectional view illustrating the sub-pixel including the light-emitting element disposed in the display area AA.

Referring to FIGS. 14A and 14B, a first buffer layer 111a and a second buffer layer 111b may be disposed in the remaining area of the substrate 110 excluding the bending area BA.

The first buffer layer 111a and the second buffer layer 111b may be disposed in the display area AA, the first non-display area NA1, and the second non-display area NA2. The first buffer layer 111a and the second buffer layer 111b may reduce the penetration of moisture or impurities through the substrate 110. The first buffer layer 111a and the second buffer layer 111b may be formed of an inorganic insulating material. For example, the first buffer layer 111a and the second buffer layer 111b may each be formed as a single layer or multiple layers of silicon oxide (SiOx) or silicon nitride (SiNx), but the embodiments of the present specification are not limited thereto.

For example, some of the first buffer layer 111a and the second buffer layer 111b located in the bending area BA may be removed. An upper surface of the substrate 110 located in the bending area BA may be exposed from the first buffer layer 111a and the second buffer layer 111b. The first buffer layer 111a and the second buffer layer 111b, which are formed of an inorganic insulating material, may be removed from the bending area BA to minimize cracks that may occur in the first buffer layer 111a and the second buffer layer 111b during bending.

A plurality of alignment keys MK may be disposed between the first buffer layer 111a and the second buffer layer 111b. The plurality of alignment keys MK may be configured to identify the position of the pixel driving circuit PD during the manufacturing process of the display device 1000. For example, the plurality of alignment keys MK may be configured to align the position of the pixel driving circuit PD that is transferred onto an adhesive layer 112. In another example, the plurality of alignment keys MK may be omitted.

The adhesive layer 112 may be disposed on the second buffer layer 111b. The adhesive layer 112 may be disposed in the display area AA, the first non-display area NA1, the bending area BA, and the second non-display area NA2. In another example, at least a portion of the adhesive layer 112 may be removed from the non-display area NA including the bending area BA. For example, the adhesive layer 112 may be formed of any one of an adhesive polymer, an epoxy resin, an ultraviolet (UV)-curable resin, a polyimide-based material, an acrylate-based material, a urethane-based material, and polydimethylsiloxane (PDMS), but the embodiments of the present specification are not limited thereto.

In the display area AA, the pixel driving circuit PD may be disposed on the adhesive layer 112. When the pixel driving circuit PD is implemented as a driving driver, the driving driver may be mounted on the adhesive layer 112 by a transfer process, but the embodiments of the present specification are not limited thereto.

A first protective layer 113a and a second protective layer 113b may be disposed on the adhesive layer 112 and the pixel driving circuit PD. The first protective layer 113a and the second protective layer 113b may be disposed to surround the side surfaces of the pixel driving circuit PD, but the embodiments of the present specification are not limited thereto. For example, the second protective layer 113b may be disposed to cover at least a portion of an upper surface of the pixel driving circuit PD. For example, at least one of the first protective layer 113a and the second protective layer 113b disposed in the bending area BA may be omitted. For example, the first protective layer 113a may be disposed in the entire display area AA and the entire non-display area NA, and the second protective layer 113b may be partially disposed in the display area AA, the first non-display area NA1, and the second non-display area NA2. For example, a portion of the second protective layer 113b in the bending area BA may be removed. However, the embodiments of the present specification are not limited thereto.

The first protective layer 113a and the second protective layer 113b may be formed of an organic insulating material, but the embodiments of the present specification are not limited thereto. For example, the first protective layer 113a and the second protective layer 113b may be formed of a photoresist, a polyimide (PI)-based material, a photo acrylic-based material, or the like, but the embodiments of the present specification are not limited thereto. For example, the first protective layer 113a and the second protective layer 113b may each be an overcoating layer or an insulating layer, but the embodiments of the present specification are not limited thereto.

According to the present specification, a plurality of first connection lines 121 may be disposed on the second protective layer 113b in the display area AA. The plurality of first connection lines 121 may be lines for electrically connecting the pixel driving circuit PD to other components. For example, the pixel driving circuit PD may be electrically connected to the plurality of signal lines TL, the plurality of contact electrodes CCE, and the like through the plurality of first connection lines 121. For example, the plurality of first connection lines 121 may include a 1-1 connection line 121a, a 1-2 connection line 121b, a 1-3 connection line 121c, and a 1-4 connection line 121d, but the embodiments of the present specification are not limited thereto.

For example, a plurality of 1-1 connection lines 121a may be disposed on the second protective layer 113b. The plurality of 1-1 connection lines 121a may be electrically connected to the pixel driving circuit PD. The plurality of 1-1 connection lines 121a may transmit a voltage output from the pixel driving circuit PD to the first electrode CE1 or the second electrode CE2.

For example, a third protective layer 114 may be disposed on the second protective layer 113b. The third protective layer 114 may be disposed in the entire display area AA and the entire non-display area NA. In the bending area BA, the third protective layer 114 may cover a side surface of the second protective layer 113b and an upper surface of the first protective layer 113a. The third protective layer 114 may be formed of an organic insulating material. For example, the third protective layer 114 may be formed of a photoresist, a polyimide (PI)-based material, a photo acrylic-based material, or the like, but the embodiments of the present specification are not limited thereto. For example, the first protective layer 113a, the second protective layer 113b, and the third protective layer 114 may be formed of the same material, but the embodiments of the present specification are not limited thereto.

A plurality of 1-2 connection lines 121b may be disposed on the third protective layer 114. The plurality of 1-2 connection lines 121b may be indirectly connected to or directly connected to the pixel driving circuit PD. For example, some of the 1-2 connection lines 121b may be directly connected to the pixel driving circuit PD through contact holes of the third protective layer 114. Another part of the 1-2 connection lines 121b may be electrically connected to the 1-1 connection line 121a through contact holes of the third protective layer 114. However, the embodiments of the present specification are not limited thereto. The voltage output from the pixel driving circuit PD may be transmitted to the first electrode CE1 or the second electrode CE2 through the plurality of 1-2 connection lines 121b and other connection lines.

A first insulating layer 115a may be disposed on the plurality of 1-2 connection lines 121b. The first insulating layer 115a may be disposed in the entire display area AA and the entire non-display area NA, but the embodiments of the present specification are not limited thereto. The first insulating layer 115a may be formed of an organic insulating material, but the embodiments of the present specification are not limited thereto. For example, the first insulating layer 115a may be formed of a photoresist, a polyimide (PI)-based material, a photo acrylic-based material, or the like, but the embodiments of the present specification are not limited thereto.

A plurality of 1-3 connection lines 121c may be disposed on the first insulating layer 115a. The plurality of 1-3 connection lines 121c may be electrically connected to the plurality of 1-2 connection lines 121b. For example, the 1-3 connection lines 121c may be electrically connected to the 1-2 connection lines 121b through contact holes of the first insulating layer 115a.

A second insulating layer 115b may be disposed on the plurality of 1-3 connection lines 121c. The second insulating layer 115b may be disposed in the remaining area excluding the bending area BA, but the embodiments of the present specification are not limited thereto. The second insulating layer 115b may be disposed in the display area AA, the first non-display area NA1, and the second non-display area NA2, but the embodiments of the present specification are not limited thereto. For example, a portion of the second insulating layer 115b disposed in the bending area BA may be removed. The second insulating layer 115b may be formed of an organic insulating material, but the embodiments of the present specification are not limited thereto. For example, the second insulating layer 115b may be formed of a photoresist, a polyimide (PI)-based material, a photo acrylic-based material, or the like, but the embodiments of the present specification are not limited thereto.

A plurality of 1-4 connection lines 121d may be disposed on the second insulating layer 115b. The plurality of 1-4 connection lines 121d may be electrically connected to the plurality of 1-3 connection lines 121c. For example, the 1-4 connection lines 121d may be electrically connected to the 1-3 connection lines 121c through contact holes of the second insulating layer 115b.

According to the present specification, a plurality of second connection lines 122 may be disposed on the second protective layer 113b in the non-display area NA. The plurality of second connection lines 122 may be lines for transmitting signals, which are transmitted from the flexible circuit board (or flexible film) CB and the printed circuit board 160 (see FIG. 1) to the pad part PAD, to the pixel driving circuit PD of the display area AA. For example, the plurality of second connection lines 122 may be electrically connected to the plurality of pad electrodes PE to receive the signals output from the flexible circuit board (or flexible film) CB and the printed circuit board.

For example, the plurality of second connection lines 122 may extend from the pad part PAD toward the display area AA and may transmit signals to the lines of the display area AA. In this case, the plurality of second connection lines 122 may function as the link lines LL. The plurality of second connection lines 122 may include a 2-1 connection line 122a, a 2-2 connection line 122b, a 2-3 connection line 122c, and a 2-4 connection line 122d.

A plurality of 2-1 connection lines 122a may be disposed on the second protective layer 113b. The plurality of 2-1 connection lines 122a may extend from the second non-display area NA2 to the bending area BA and the first non-display area NA1. The plurality of 2-1 connection lines 122a may transmit signals, which are transmitted to the pad part PAD from the flexible circuit board (or flexible film) CB and the printed circuit board, to the pixel driving circuit PD of the display area AA.

A plurality of 2-2 connection lines 122b may be disposed on the third protective layer 114. The plurality of 2-2 connection lines 122b may be disposed in the second non-display area NA2. The 2-2 connection lines 122b may be electrically connected to the 2-1 connection lines 122a through contact holes of the third protective layer 114. Accordingly, the signals output from the flexible circuit board (or flexible film) CB and the printed circuit board may be transmitted to the 2-1 connection lines 122a through the 2-2 connection lines 122b.

The 2-3 connection line 122c may be disposed on the first insulating layer 115a. The 2-3 connection line 122c may be disposed in the second non-display area NA2. The 2-3 connection line 122c may be electrically connected to the 2-2 connection line 122b through a contact hole of the first insulating layer 115a. Accordingly, the signals output from the flexible circuit board (or flexible film) CB and the printed circuit board may be transmitted to the 2-1 connection lines 122a through the 2-3 connection line 122c and the 2-2 connection lines 122b.

The 2-4 connection line 122d may be disposed on the second insulating layer 115b. The 2-4 connection line 122d may be disposed in the second non-display area NA2. The 2-4 connection line 122d may be electrically connected to the 2-3 connection line 122c through the contact hole of the second insulating layer 115b. Accordingly, the signals output from the flexible circuit board (or flexible film) CB may be transmitted to the 2-1 connection lines 122a through the 2-4 connection line 122d, the 2-3 connection line 122c, and the 2-2 connection lines 122b.

The plurality of first connection lines 121 and the plurality of second connection lines 122 may be formed of a highly flexible conductive material or any of the various conductive materials used in the display area AA. For example, the second connection lines 122, some of which are disposed in the bending area BA, may be formed of a highly flexible conductive material such as gold (Au), silver (Ag), or aluminum (Al), but the embodiments of the present specification are not limited thereto. In another example, the plurality of first connection lines 121 and the plurality of second connection lines 122 may be formed of molybdenum (Mo), chromium (Cr), titanium (Ti), nickel (Ni), neodymium (Nd), copper (Cu), an alloy of silver (Ag) and magnesium (Mg), alloys thereof, or the like, but the embodiments of the present specification are not limited thereto.

A third insulating layer 115c may be disposed on the plurality of first connection lines 121 and the plurality of second connection lines 122. The third insulating layer 115c may be disposed in the remaining area excluding the bending area BA, but the embodiments of the present specification are not limited thereto. The third insulating layer 115c may be disposed in the display area AA, the first non-display area NA1, and the second non-display area NA2. A portion of the third insulating layer 115c in the bending area BA may be removed. The third insulating layer 115c may be formed of an organic insulating material, but the embodiments of the present specification are not limited thereto. For example, the third insulating layer 115c may be formed of a photoresist, a polyimide (PI)-based material, a photo acrylic-based material, or the like, but the embodiments of the present specification are not limited thereto.

In the display area AA, a plurality of banks BNK may be disposed on the third insulating layer 115c. The plurality of banks BNK may be disposed to overlap the plurality of sub-pixels, respectively. At least one or more light-emitting elements ED of the same type may be disposed on each of the plurality of banks BNK.

A plurality of signal lines TL may be disposed on the third insulating layer 115c in the display area AA. The plurality of signal lines TL may be disposed in an area between the plurality of banks BNK. For example, the plurality of signal lines TL may be disposed adjacent to any one of the plurality of banks BNK.

A plurality of contact electrodes CCE may be disposed on the third insulating layer 115c in the display area AA. The plurality of contact electrodes CCE may supply a cathode voltage output from the pixel driving circuit PD to the second electrode CE2.

The first electrode CE1 may be disposed on the bank BNK. For example, the first electrode CE1 may be disposed to extend toward an upper portion of the bank BNK from the adjacent signal line TL. The first electrode CE1 may be disposed on upper and side surfaces of the bank BNK. For example, the first electrode CE1 may be disposed to extend from the signal line TL on an upper surface of the third insulating layer 115c to the side and upper surfaces of the bank BNK.

The first electrode CE1 and the contact electrode CCE may be formed of a plurality of conductive layers. The first electrode CE1 and the contact electrode CCE may be formed by the same process, and each of the first electrode CE1 and the second electrode CE2 may include the same plurality of conductive layers.

The first electrode CE1 may include a first conductive layer CE1a, a second conductive layer CE1b, a third conductive layer CE1c, and a fourth conductive layer CE1d, but the embodiments of the present specification are not limited thereto.

The first conductive layer CE1a may be disposed on the bank BNK. The second conductive layer CE1b may be disposed on the first conductive layer CE1a. The third conductive layer CE1c may be disposed on the second conductive layer CE1b. The fourth conductive layer CE1d may be disposed on the third conductive layer CE1c. For example, the first conductive layer CE1a, the second conductive layer CE1b, the third conductive layer CE1c, and the fourth conductive layer CE1d may each be formed of at least one of titanium (Ti), molybdenum (Mo), aluminum (Al), titanium (Ti), and indium tin oxide (ITO), but the embodiments of the present specification are not limited thereto.

According to the present specification, among the plurality of conductive layers forming the first electrode CE1, some conductive layers with high reflectivity may be configured as alignment keys and/or reflectors for the alignment of the light-emitting element ED. For example, among the plurality of conductive layers of the first electrode CE1, the second conductive layer CE1b may include a reflective material. For example, the second conductive layer CE1b may include aluminum (Al), but the embodiments of the present specification are not limited thereto. Accordingly, the second conductive layer CE1b may be configured as a reflector. Further, due to the high reflectivity of the second conductive layer CE1b, identification may be facilitated in the manufacturing process, thereby allowing the position or transfer position of the light-emitting element ED to be aligned based on the second conductive layer CE1b.

For example, to configure the second conductive layer CE1b as a reflector, the third conductive layer CE1c and the fourth conductive layer CE1d covering the second conductive layer CE1b may be partially removed or etched. For example, some of the third conductive layer CE1c and the fourth conductive layer CE1d may be removed or etched to expose an upper surface of the second conductive layer CE1b. For example, in each of the third conductive layer CE1c and the fourth conductive layer CE1d, a central portion on which the solder pattern SDP is disposed and edge portions may be retained, whereas the remaining portions may be removed. For example, the edge portions of each of the third conductive layer CE1c, which is formed of titanium (Ti), and the fourth conductive layer CE1d, which is formed of indium tin oxide (ITO), may not be etched. Accordingly, it is possible to prevent other conductive layers of the first electrode CE1, such as the second conductive layer CE1b, from being corroded by a tetramethylammonium hydroxide (TMAH) solution used in the masking process forming the first electrode CE1.

According to the present specification, the first conductive layer CE1a and the third conductive layer CE1c may include titanium (Ti) or molybdenum (Mo). The second conductive layer CE1b may include aluminum (Al). The fourth conductive layer CE1d may include a transparent conductive oxide layer, such as indium tin oxide (ITO) or indium zinc oxide (IZO), which has good adhesion to the solder pattern SDP and exhibits corrosion resistance and acid resistance. However, the embodiments of the present specification are not limited thereto.

The first conductive layer CE1a, the second conductive layer CE1b, the third conductive layer CE1c, and the fourth conductive layer CE1d may be sequentially deposited and then patterned through a photolithography process and an etching process, but the embodiments of the present specification are not limited thereto.

According to the present specification, the signal line TL, contact electrode CCE, and pad electrode PE, which are disposed on the same layer as the first electrode CE1, may be formed as multiple layers of conductive materials, but the embodiments of the present specification are not limited thereto. For example, the signal line TL, the contact electrode CCE, and the pad electrode PE may be formed as multiple layers of indium tin oxide (ITO)/titanium (Ti)/aluminum (Al)/titanium (Ti), but the embodiments of the present specification are not limited thereto.

According to the present specification, the solder pattern SDP may be disposed on the first electrode CE1 in each of the plurality of sub-pixels. The solder pattern SDP may allow the light-emitting element ED to be bonded to the first electrode CE1. The first electrode CE1 and the light-emitting element ED may be electrically connected through eutectic bonding using the solder pattern SDP, but the embodiments of the present specification are not limited thereto. For example, the first electrode CE1 and the anode 134 of the light-emitting element ED may be electrically connected through eutectic bonding using the solder pattern SDP, but the embodiments of the present specification are not limited thereto. For example, when the solder pattern SDP is formed of indium (In) and the anode 134 of the light-emitting element ED is formed of gold (Au), the solder pattern SDP and the anode 134 may be bonded by applying heat and pressure during the transfer process of the light-emitting element ED. Through eutectic bonding, the light-emitting element ED may be bonded to the solder pattern SDP and the first electrode CE1 without any additional adhesive. For example, the solder pattern SDP may be formed of indium (In), tin (Sn), or an alloy thereof, but the embodiments of the present specification are not limited thereto. For example, the solder pattern SDP may be a pattern layer, a bonding pad, a joining pad, or the like, but the embodiments of the present specification are not limited thereto.

According to the present specification, a passivation layer 116 may be disposed on the plurality of signal lines TL, the plurality of first electrodes CE1, the plurality of contact electrodes CCE, and the third insulating layer 115c. For example, the passivation layer 116 may be disposed in the display area AA, the first non-display area NA1, and the second non-display area NA2. A portion of the passivation layer 116 disposed in the bending area BA may be removed. In the second non-display area NA2, a portion of the passivation layer 116 covering the plurality of pad electrodes PE may be removed. The passivation layer 116 may be disposed to cover remaining areas except for the bending area BA, the area in which the plurality of pad electrodes PE and the solder pattern SDP are disposed, and a partial area of the contact electrode CCE that is exposed for connection to the second electrode CE2, thereby reducing the penetration of moisture or impurities into the light-emitting element ED. For example, the passivation layer 116 may be formed as a single layer or multiple layers of silicon oxide (SiOx) or silicon nitride (SiNx), but the embodiments of the present specification are not limited thereto. For example, the passivation layer 116 may be a protective layer, an insulating layer, or the like, but the embodiments of the present specification are not limited thereto. In addition, the passivation layer 116 may be formed to have a thickness of 1000 to 2000 Å, which is smaller than a thickness of the second electrode CE2.

In each of the plurality of sub-pixels, the light-emitting element ED may be disposed on the solder pattern SDP. In the first sub-pixel SP1, the first light-emitting element 130 may be disposed. In the second sub-pixel SP2, the second light-emitting element 140 may be disposed. The third light-emitting element 150 disposed in the third sub-pixel SP3.

The light-emitting element ED may be formed on a silicon wafer using methods such as metal organic chemical vapor deposition (MOCVD), chemical vapor deposition (CVD), plasma-enhanced chemical vapor deposition (PECVD), molecular beam epitaxy (MBE), hydride vapor phase epitaxy (HVPE), or sputtering, but the embodiments of the present specification are not limited thereto.

Referring to FIG. 15, the first light-emitting element 130 may include an anode 134, a first semiconductor layer 131, an active layer 132, a second semiconductor layer 133, a cathode 135, and an encapsulation film 136, but the embodiments of the present specification are not limited thereto. For example, the first light-emitting element 130 may not include the encapsulation film 136.

The first semiconductor layer 131 may be disposed on the solder pattern SDP. The second semiconductor layer 133 may be disposed on the first semiconductor layer 131.

For example, one of the first semiconductor layer 131 and the second semiconductor layer 133 may be implemented as a group III-V compound semiconductor, a group II-VI compound semiconductor, or the like and may be doped with impurities (or dopants). For example, one of the first semiconductor layer 131 and the second semiconductor layer 133 may be a semiconductor layer doped with n-type impurities, and the other may be a semiconductor layer doped with p-type impurities, but the embodiments of the present specification are not limited thereto. For example, one or more of the first semiconductor layer 131 and the second semiconductor layer 133 may be a layer doped with n-type or p-type impurities in a material such as gallium nitride (GaN), gallium phosphide (GaP), gallium arsenide phosphide (GaAsP), aluminum gallium indium phosphide (AlGaInP), indium aluminum phosphide (InAIP), aluminum gallium nitride (AlGaN), aluminum indium nitride (AlInN), aluminum indium gallium nitride (AlInGaN), aluminum gallium arsenide (AlGaAs), gallium arsenide (GaAs), or the like, but the embodiments of the present specification are not limited thereto. For example, the n-type impurities may include silicon (Si), germanium (Ge), selenium (Se), carbon (C), tellurium (Te), tin (Sn), and the like, but the embodiments of the present specification are not limited thereto. For example, the p-type impurities may include magnesium (Mg), zinc (Zn), calcium (Ca), strontium (Sr), barium (Ba), beryllium (Be), and the like, but the embodiments of the present specification are not limited thereto.

For example, the first semiconductor layer 131 and the second semiconductor layer 133 may be a nitride semiconductor containing n-type impurities and a nitride semiconductor containing p-type impurities, respectively, but the embodiments of the present specification are not limited thereto. For example, the first semiconductor layer 131 may be a nitride semiconductor containing p-type impurities, and the second semiconductor layer 133 may be a nitride semiconductor containing n-type impurities, but the embodiments of the present specification are not limited thereto.

The active layer 132 may be disposed between the first semiconductor layer 131 and the second semiconductor layer 133. The active layer 132 may emit light by receiving holes and electrons from the first semiconductor layer 131 and the second semiconductor layer 133. For example, the active layer 132 may include one of a single well structure, a multi-well structure, a single quantum well structure, a multi-quantum well (MQW) structure, a quantum dot structure, and a quantum wire structure, but the embodiments of the present specification are not limited thereto. For example, the active layer 132 may be formed of indium gallium nitride (InGaN), gallium nitride (GaN), or the like, but the embodiments of the present specification are not limited thereto.

In another example, the active layer 132 may include a multi-quantum well (MQW) structure having a well layer and a barrier layer with a higher bandgap than the well layer. For example, the active layer 132 may include an InGaN well layer and an AlGaN barrier layer, but the embodiments of the present specification are not limited thereto.

The anode 134 may be disposed between the first semiconductor layer 131 and the solder pattern SDP. For example, the anode 134 may electrically connect the first semiconductor layer 131 and the first electrode CE1. An anode voltage output from the pixel driving circuit PD may be applied to the first semiconductor layer 131 through the signal line TL, the first electrode CE1, and the anode 134. For example, the anode 134 may be formed of a conductive material capable of eutectic bonding with the solder pattern SDP, but the embodiments of the present specification are not limited thereto. For example, the anode 134 may be formed of gold (Au), tin (Sn), tungsten (W), silicon (Si), silver (Ag), titanium (Ti), iridium (Ir), chromium (Cr), indium (In), zinc (Zn), lead (Pb), nickel (Ni), platinum (Pt), copper (Cu), or an alloy thereof, but the embodiments of the present specification are not limited thereto.

The cathode 135 may be disposed on the second semiconductor layer 133. For example, the cathode 135 may electrically connect the second semiconductor layer 133 and the second electrode CE2. A cathode voltage output from the pixel driving circuit PD may be applied to the second semiconductor layer 133 through the contact electrode CCE, the second electrode CE2, and the cathode 135. The cathode 135 may be formed of a transparent conductive material to allow light emitted from the light-emitting element ED to be directed upward, but the embodiments of the present specification are not limited thereto. For example, the cathode 135 may be formed of a material such as indium tin oxide (ITO), indium zinc oxide (IZO), or indium gallium zinc oxide (IGZO), but the embodiments of the present specification are not limited thereto.

The encapsulation film 136 may be disposed on at least some of the first semiconductor layer 131, the active layer 132, the second semiconductor layer 133, the anode 134, and the cathode 135. For example, the encapsulation film 136 may surround at least some of the first semiconductor layer 131, the active layer 132, the second semiconductor layer 133, the anode 134, and the cathode 135.

For example, the encapsulation film 136 may protect the first semiconductor layer 131, the active layer 132, and the second semiconductor layer 133. For example, the encapsulation film 136 may be disposed on the side surfaces of the first semiconductor layer 131, the active layer 132, and the second semiconductor layer 133.

For example, the encapsulation film 136 may be disposed on at least a portion of each of the anode 134 and the cathode 135, for example, on an edge portion (or one side) of the anode 134 and an edge portion (or one side) of the cathode 135. At least a portion of the anode 134 may be exposed from the encapsulation film 136, thereby allowing the anode 134 to be connected to the solder pattern SDP. For example, at least a portion of the cathode 135 may be exposed from the encapsulation film 136, thereby allowing the cathode 135 to be connected to the second electrode CE2. For example, the encapsulation film 136 may be formed of an insulating material such as silicon nitride (SiNx) or silicon oxide (SiOx), but the embodiments of the present specification are not limited thereto.

In another example, the encapsulation film 136 may have a structure in which a reflective material is dispersed in a resin layer, but the embodiments of the present specification are not limited thereto. For example, the encapsulation film 136 may be fabricated as a reflector with various structures, but the embodiments of the present specification are not limited thereto. Light emitted from the active layer 132 may be reflected upward by the encapsulation film 136, thereby enhancing light extraction efficiency. For example, the encapsulation film 136 may be a reflective layer, but the embodiments of the present specification are not limited thereto.

According to the present specification, the light-emitting element ED has been described as having a vertical structure in which a light-emitting structure is disposed between the anode and the cathode, but the embodiments of the present specification are not limited thereto. For example, the light-emitting element ED may have a lateral structure or a flip chip structure.

Although the first light-emitting element 130 has been described with reference to FIG. 15, but the second light-emitting element 140 and the third light-emitting element 150 may have substantially the same structure as the first light-emitting element 130. For example, the second light-emitting element 140 and the third light-emitting element 150 may have substantially the same structure as the first semiconductor layer 131, the active layer 132, the second semiconductor layer 133, the anode 134, the cathode 135, and the encapsulation film 136 of the first light-emitting element 130. The light-emitting structure may include the first semiconductor layer 131, the active layer 132, and the second semiconductor layer 133.

According to the present specification, a first optical layer 117a surrounding the plurality of light-emitting elements ED in the display area AA may be disposed. For example, the first optical layers 117a may be disposed to cover the plurality of light-emitting elements ED and the banks BNK in the areas of the plurality of sub-pixels. For example, the first optical layers 117a may cover the banks BNK, a portion of the passivation layer 116, and spaces between the plurality of light-emitting elements ED. The first optical layers 117a may be disposed or may cover the spaces between the plurality of light-emitting elements ED included in one pixel PX and between the plurality of banks BNK. For example, the first optical layers 117a may extend in a first direction (X-axis direction) and may be disposed spaced apart in a second direction (Y-axis direction). For example, the first optical layer 117a may be disposed to surround the side portions of the light-emitting element ED and the bank BNK between the passivation layer 116 and the second electrode CE2, but the embodiments of the present specification are not limited thereto. For example, the first optical layer 117a may be a diffusion layer, a sidewall diffusion layer, or the like, but the embodiments of the present specification are not limited thereto.

The first optical layer 117a may include an organic insulating material in which fine particles are dispersed, but the embodiments of the present specification are not limited thereto. For example, the first optical layer 117a may be formed of siloxane in which fine metal particles, such as titanium dioxide (TiO₂) particles, are dispersed, but the embodiments of the present specification are not limited thereto. Light emitted from the plurality of light-emitting elements ED may be scattered by the fine particles dispersed in the first optical layer 117a and emitted to the outside of the display device 1000. Accordingly, the first optical layer 117a may improve the extraction efficiency of the light emitted from the plurality of light-emitting elements ED.

For example, the first optical layer 117a may be disposed in each of the plurality of pixels PX, or the first optical layers 117a may be disposed together with some of the pixels PX disposed in the same row, but the embodiments of the present specification are not limited thereto. For example, the first optical layer 117a may be disposed in each of the plurality of pixels PX, or the plurality of pixels PX may share one first optical layer 117a. In another example, each of the plurality of sub-pixels may separately include the first optical layer 117a, but the embodiments of the present specification are not limited thereto.

According to the present specification, a second optical layer 117b may be disposed on the passivation layer 116 in the display area AA. For example, the second optical layer 117b may be disposed to surround the first optical layer 117a. For example, the second optical layer 117b may be in contact with a side surface of the first optical layer 117a. For example, the second optical layer 117b may be disposed in the area between the plurality of pixels PX. However, the embodiments of the present specification are not limited thereto, and for example, the second optical layer 117b may be a diffusion layer, a diffusion layer window, a window diffusion layer, or the like, but the embodiments of the present specification are not limited thereto.

The second optical layer 117b may be formed of an organic insulating material, but the embodiments of the present specification are not limited thereto. The second optical layer 117b may be formed of the same material as the first optical layer 117a, but the embodiments of the present specification are not limited thereto. For example, the first optical layer 117a may include fine particles, and the second optical layer 117b may not include fine particles. For example, the second optical layer 117b may be formed of siloxane, but the embodiments of the present specification are not limited thereto.

For example, a thickness of the first optical layer 117a may be less than a thickness of the second optical layer 117b, but the embodiments of the present specification are not limited thereto. Accordingly, when viewed in a plan view, an area in which the first optical layer 117a is disposed may include a recessed portion that is recessed inward relative to an upper surface of the second optical layer 117b.

According to the present specification, the second electrode CE2 may be disposed on the first optical layer 117a and the second optical layer 117b. For example, the second electrode CE2 may be electrically connected to the plurality of contact electrodes CCE through a contact hole of the second optical layer 117b. For example, the second electrode CE2 may be disposed on the plurality of light-emitting elements ED. For example, the second electrode CE2 may include a transparent conductive oxide such as indium tin oxide (ITO) or indium zinc oxide (IZO), but the embodiments of the present specification are not limited thereto. For example, the second electrode CE2 may be disposed to be in contact with the cathode 135. For example, the second electrode CE2 may overlap the first optical layer 117a. For example, the second electrode CE2 may cover a plane on an outer side of the first optical layer 117a.

The second electrode CE2 may continuously extend in the first direction (X-axis direction) of the substrate 110. Accordingly, the second electrode CE2 may be commonly connected to the plurality of pixels PX arranged in the first direction (X-axis direction) of the substrate 110. For example, the second electrode CE2 may be commonly connected to a plurality of pixels PX.

According to the present specification, the second electrode CE2 may continuously extend on the first optical layer 117a, the second optical layer 117b, and the light-emitting element ED. The area in which the first optical layer 117a is disposed may include a recessed portion that is recessed inward relative to the upper surface of the second optical layer 117b. Accordingly, since a first portion of the second electrode CE2 disposed on the first optical layer 117a is disposed along the recessed portion, the first portion of the second electrode CE2 may be disposed at a position lower than that of a second portion of the second electrode CE2 disposed on the second optical layer 117b.

A third optical layer 117c may be disposed on the second electrode CE2. The third optical layer 117c may be disposed to overlap the plurality of light-emitting elements ED and the first optical layer 117a. Since the third optical layer 117c is disposed on the second electrode CE2 and the plurality of light-emitting elements ED, the third optical layer 117c may improve the mura that may occur in some of the plurality of light-emitting elements ED. For example, when transferring the plurality of light-emitting elements ED onto the substrate 110 of the display device 1000, an area in which intervals between the plurality of light-emitting elements ED are not uniform may occur due to process variations or the like. When the intervals between the plurality of light-emitting elements ED are not uniform, light emission areas of each of the plurality of light-emitting elements ED may be disposed unevenly, which may cause a user to perceive mura. Accordingly, by configuring the third optical layer 117c to uniformly diffuse light over the plurality of light-emitting elements ED, the occurrence of light emitted from some light-emitting elements ED appearing as mura can be reduced. Accordingly, the light emitted from the plurality of light-emitting elements ED is evenly diffused by the third optical layer 117c and extracted to the outside of the display device 1000, thereby improving the luminance uniformity of the display device 1000.

The third optical layer 117c may be formed of an organic insulating material in which fine particles are dispersed, but the embodiments of the present specification are not limited thereto. For example, the third optical layer 117c may be formed of siloxane in which fine metal particles, such as titanium dioxide (TiO₂) particles, are dispersed, but the embodiments of the present specification are not limited thereto. For example, the third optical layer 117c may be formed of the same material as the first optical layer 117a, but the embodiments of the present specification are not limited thereto. For example, the third optical layer 117c may be a diffusion layer, an upper diffusion layer, or the like, but the embodiments of the present specification are not limited thereto.

According to the present specification, light emitted from the plurality of light-emitting elements ED may be scattered by the fine particles dispersed in the third optical layer 117c and emitted to the outside of the display device 1000. The third optical layer 117c may evenly mix the light emitted from the plurality of light-emitting elements ED, thereby further improving the luminance uniformity of the display device 1000. In addition, the light extraction efficiency of the display device 1000 may be improved by the light scattered from the plurality of fine particles, thereby enabling the display device 1000 to operate at lower power.

In the display area AA, the black matrix BM may be disposed on the second electrode CE2, the first optical layer 117a, the second optical layer 117b, and the third optical layer 117c. For example, the contact hole of the second optical layer 117b may be filled with the black matrix BM. The black matrix BM is configured to cover the display area AA, and thus may reduce the color mixing of light from the plurality of sub-pixels and the reflection of external light. For example, the black matrix BM is also disposed in a contact hole in which the second electrode CE2 and the contact electrode CCE are connected, and thus may prevent light leakage between the plurality of adjacent sub-pixels.

For example, the black matrix BM may be formed of an opaque material, but the embodiments of the present specification are not limited thereto. For example, the black matrix BM may be an organic insulating material containing a black pigment or a black dye, but the embodiments of the present specification are not limited thereto.

In the display area AA, a cover layer 118 may be disposed on the black matrix BM. The cover layer 118 may protect the configuration below the cover layer 118, and for example, the cover layer 118 may be formed of an organic insulating material, but the embodiments of the present specification are not limited thereto. For example, the cover layer 118 may be formed of a photoresist, a polyimide (PI)-based material, a photo acrylic-based material, or the like, but the embodiments of the present specification are not limited thereto. For example, the cover layer 118 may be an overcoating layer, an insulating layer, or the like, but the embodiments of the present specification are not limited thereto.

The polarizing layer 293 may be disposed on the cover layer 118 through a first adhesive layer 291. The cover member 120 may be disposed on the polarizing layer 293 through a second adhesive layer 295. For example, the first adhesive layer 291 and the second adhesive layer 295 may include an optically clear adhesive (OCA), an optically clear resin (OCR), a pressure sensitive adhesive (PSA), or the like, but the embodiments of the present specification are not limited thereto.

According to the present specification, a plurality of pad electrodes PE may be disposed on the third insulating layer 115c in the second non-display area NA2. For example, at least some of the plurality of pad electrodes PE may be exposed from the passivation layer 116. For example, the plurality of pad electrodes PE may be electrically connected to the 2-4 connection line 122d through contact holes of the third insulating layer 115c.

An adhesive layer ACF may be disposed on the plurality of pad electrodes PE. The adhesive layer ACF may be an adhesive layer in which conductive balls are dispersed in an insulating material, but the embodiments of the present specification are not limited thereto. When heat or pressure is applied to the adhesive layer ACF, the conductive balls at the portions to which the heat or pressure is applied may become electrically connected, thereby exhibiting conductive properties. The adhesive layer ACF may be disposed between the plurality of pad electrodes PE and the flexible circuit board (or flexible film) CB, thereby allowing the flexible circuit board (or flexible film) CB to be attached or bonded to the plurality of pad electrodes PE. For example, the adhesive layer ACF may be an anisotropic conductive film (ACF), but the embodiments of the present specification are not limited thereto.

The flexible circuit board (or flexible film) CB may be disposed on the adhesive layer ACF. The flexible circuit board (or flexible film) CB may be electrically connected to the plurality of pad electrodes PE through the adhesive layer ACF. Accordingly, signals output from the flexible circuit board (or flexible film) CB and the printed circuit board may be transmitted to the pixel driving circuit PD of the display area AA through the plurality of pad electrodes PE, and the 2-4 connection line 122d, the 2-3 connection line 122c, the 2-2 connection line 122b, and the 2-1 connection line 122a.

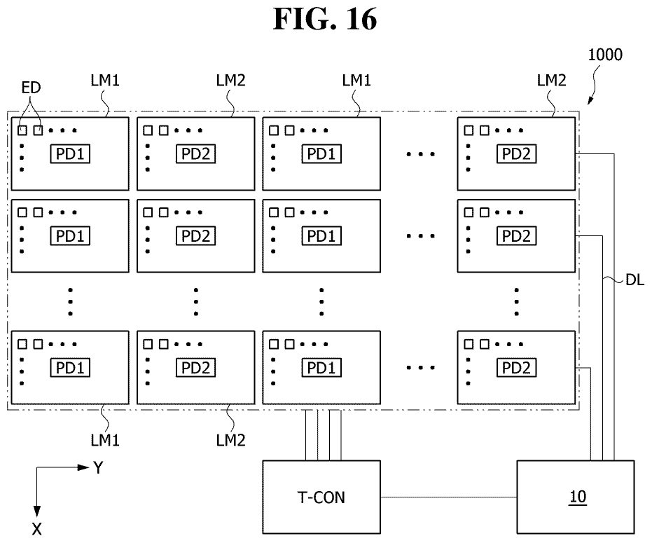

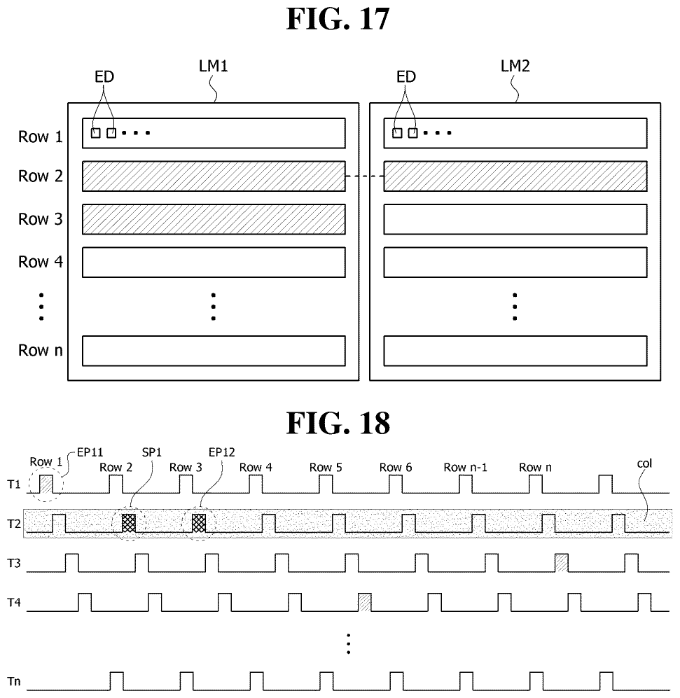

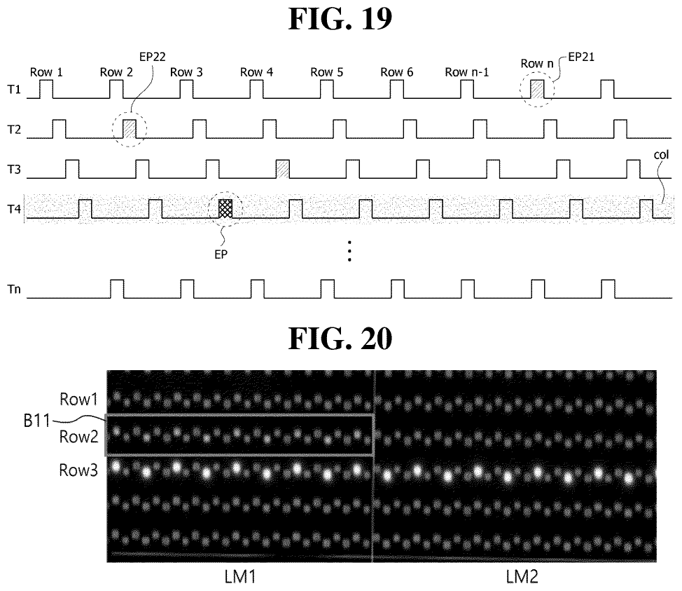

FIG. 16 is a view illustrating a defect detection device for the display device according to an embodiment of the present specification. FIG. 17 is a view illustrating a state in which a short circuit has occurred between the second horizontal lines of the display device according to an embodiment of the present specification. FIG. 18 is a timing diagram of the first pixel driving circuit according to an embodiment of the present specification. FIG. 19 is a timing diagram of the second pixel driving circuit according to an embodiment of the present specification.

A defect detection method according to the present specification may include preparing the display device in which the plurality of first light-emitting regions LM1 and the plurality of second light-emitting regions LM2 are alternately disposed, emitting light from the first light-emitting region LM1 and the second light-emitting region LM2 by driving the horizontal lines in different orders, and checking whether light is emitted from the horizontal lines other than the driven horizontal line.

The preparing of the display device in which the plurality of first light-emitting regions LM1 and the plurality of second light-emitting regions LM2 are alternately disposed may be preparing for inspection by connecting a detection device 10 to the above-described display device.

Referring to FIG. 16, the detection device 10 may cause the light-emitting elements in the first light-emitting region LM1 and the second light-emitting region LM2 of the display device to emit light in a predetermined order and may inspect the light-emitting elements that have emitted light for each horizontal line. For example, an inspector may write the order of horizontal lines into a timing controller T-CON of the display device using the detection device 10. The timing controller T-CON may drive the light-emitting elements on the horizontal lines of the first light-emitting region LM1 and the second light-emitting region LM2 according to the written order.

Various types of detection devices, which are connected to the display device and capable of controlling the driving order of horizontal lines, may be applied as the detection device 10. For example, the detection device 10 may be a test device connected to the timing controller T-CON, but the present specification is not limited thereto.

The emitting of the light from the first light-emitting region LM1 and the second light-emitting region LM2 by driving the horizontal lines in different orders may include causing the light-emitting elements to emit light by setting different driving orders for the horizontal lines of the first light-emitting region LM1 and the horizontal lines of the second light-emitting region LM2.

Since the first light-emitting region LM1 and the second light-emitting region LM2 have different driving orders, light may not be emitted simultaneously from the horizontal line in the first light-emitting region LM1 and the horizontal line in the second light-emitting region LM2, which correspond to the same line number.

For example, in the first light-emitting region LM1, the horizontal lines may be driven in the order of 1, 3, n, 5, . . . , and 2, whereas in the second light-emitting region LM2, the horizontal lines may be driven in the order of n, 2, 4, 3, . . . , and 1. For example, when the first horizontal line of the first light-emitting region LM1 is driven during a first horizontal period, the n-th horizontal line of the second light-emitting region LM2 may be driven. When a third horizontal line of the first light-emitting region LM1 is driven during a second horizontal period, a second horizontal line of the second light-emitting region LM2 may be driven.

Referring to FIG. 17, it may be confirmed that, when the first light-emitting region LM1 is configured to cause the light-emitting elements ED of a third horizontal line Row 3 to emit light and the second light-emitting region LM2 is configured to cause the light-emitting elements ED of the second horizontal line Row 2 to emit light during the second horizontal period, in the first light-emitting region LM1, the light-emitting elements ED of the second horizontal line Row 2 emit light together with the light-emitting elements ED of the third horizontal line Row 3. This may be caused by a short circuit occurring between the second horizontal line Row 2 of the first light-emitting region LM1 and the second horizontal line Row 2 of the second light-emitting region LM2.

In the first light-emitting region LM1, the second electrodes may be disposed for each horizontal line, and in the second light-emitting region LM2, the second electrodes may also be disposed for each horizontal line. Accordingly, the second electrodes may be designed to be electrically insulated from each other for each horizontal line in the first light-emitting region LM1, and the second electrodes of the first light-emitting region LM1 and the second electrodes of the second light-emitting region LM2 may also be designed to be electrically insulated from each other. However, due to manufacturing tolerances or the like, a short circuit may occur between the second electrode of the first light-emitting region LM1 and the second electrode of the second light-emitting region LM2.

Referring to FIGS. 18 and 19, during a first horizontal period T1, the first pixel driving circuit of the first light-emitting region LM1 may apply the low-potential power supply voltage to the first horizontal line Row 1 and sequentially apply the high-potential power supply voltage to the vertical lines, thereby causing the light-emitting elements of the first horizontal line Row 1 to emit light (EP11).

During a second horizontal period T2, in order to drive the light-emitting elements of the third horizontal line Row 3, the first pixel driving circuit of the first light-emitting region LM1 may apply the low-potential power supply voltage to the third horizontal line Row 3 and apply the high-potential power supply voltage to the vertical lines Col, thereby causing the light-emitting elements of the third horizontal line Row 3 to emit light (EP12).

During the first horizontal period T1, in order to drive the light-emitting elements of the n-th horizontal line Row n, the second pixel driving circuit of the second light-emitting region LM2 may apply the low-potential power supply voltage to the n-th horizontal line Row n and apply the high-potential power supply voltage to the vertical lines, thereby causing the light-emitting elements of the n-th horizontal line Row n to emit light (EP21).

During the second horizontal period T2, in order to drive the light-emitting elements of the second horizontal line Row 2, the second pixel driving circuit may apply the low-potential power supply voltage to the second horizontal line Row 2 and apply the high-potential power supply voltage to the vertical lines, thereby causing the light-emitting elements of the second horizontal line Row 2 to emit light (EP22).

In the second horizontal period T2, the low-potential power supply voltage is applied only to the light-emitting elements of the third horizontal line Row 3 in the first light-emitting region LM1, and the low-potential power supply voltage is not applied to the light-emitting elements of the second horizontal line Row 2. Accordingly, even when the high-potential power supply voltage is applied to the light-emitting elements of the second horizontal line Row 2 in the process of applying the high-potential power supply voltage to the vertical lines Col, the light-emitting elements of the second horizontal line Row 2 should not emit light.

However, when the second electrode of the second horizontal line Row 2 of the first light-emitting region LM1 is short circuited to the second electrode of the second horizontal line Row 2 of the second light-emitting region LM2, the low-potential power supply voltage may also be applied to the light-emitting elements of the second horizontal line Row 2 of the first light-emitting region LM1 when the low-potential power supply voltage is applied to the light-emitting elements of the second horizontal line Row 2 of the second light-emitting region LM2 during the second horizontal period T2. Accordingly, when the high-potential power supply voltage is applied to the vertical lines Col of the first light-emitting region LM1 during the second horizontal period T2, the light-emitting elements of the second horizontal line Row 2 of the first light-emitting region LM1 may also emit light (SP1).

In a fourth horizontal period T4, the low-potential power supply voltage may be applied to the light-emitting elements of the third horizontal line Row 3 of the second light-emitting region LM2, and the high-potential power supply voltage may be applied to the vertical lines Col, thereby causing the light-emitting elements of the third horizontal line Row 3 to emit light (EP).

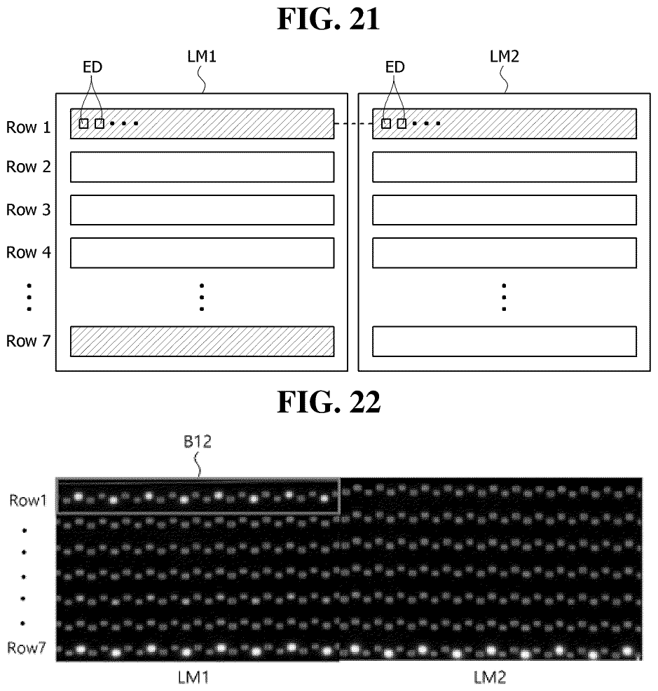

FIG. 20 is a photograph illustrating a process of inspecting a light emission pattern of the third horizontal line according to an embodiment of the present specification. FIG. 21 is a view illustrating a state in which a short circuit has occurred between the first horizontal lines of the display device according to an embodiment of the present specification. FIG. 22 is a photograph illustrating a process of inspecting a light emission pattern of the seventh horizontal line according to the embodiment of an present specification.

Referring to FIG. 20, in the inspection operation, a defective line may be detected by checking light emission patterns of the horizontal line in the first light-emitting region LM1 and the horizontal line the second light-emitting region LM2, which correspond to the same line number.

The inspection may be performed for each horizontal line, but the embodiments of the present specification are not limited thereto. For example, when inspecting light emission patterns of the third horizontal line Row 3 of the first light-emitting region LM1 and the third horizontal line Row 3 of the second light-emitting region LM2, the light emission patterns of the third horizontal lines may be inspected using an image of the third horizontal lines from which light is emitted during different horizontal periods.

For example, the light emission from the light-emitting elements of the third horizontal line Row 3 in the first light-emitting region LM1 may correspond to the image captured during the second horizontal period, and the light emission from the light-emitting elements of the third horizontal line Row 3 in the second light-emitting region LM2 may correspond to the image captured during the fourth horizontal period. The light emission pattern inspection for each horizontal line may be performed by comparing images of the light-emitting elements, which have emitted light during different horizontal periods, of the horizontal lines corresponding to the same line number.

As a result of inspecting the light emission pattern of the light-emitting elements on the third horizontal line Row 3, it may be confirmed that the light-emitting elements on the second horizontal line Row 2 in the first light-emitting region LM1 also emit light (B11). Accordingly, it can be detected that a short circuit has occurred between the second horizontal line Row 2 of the first light-emitting region LM1 and the second horizontal line Row 2 of the second light-emitting region LM2.

Referring to FIG. 21, when the first light-emitting region LM1 is controlled to cause the light-emitting elements of a seventh horizontal line Row 7 to emit light, and the second light-emitting region LM2 is controlled to cause the light-emitting elements of the first horizontal line Row 1 to emit light, it may be confirmed that, in the first light-emitting region LM1, light is emitted from the light-emitting elements of the first horizontal line Row 1 together with those of the seventh horizontal line Row 7. This may be caused by a short circuit occurring between the second electrode of the first horizontal line Row 1 in the first light-emitting region LM1 and the second electrode of the first horizontal line Row 1 of the second light-emitting region LM2.

Referring to FIG. 22, when detecting the light emission pattern of the seventh horizontal line Row 7, it may be confirmed that, the light-emitting elements of the first horizontal line Row 1 in the first light-emitting region LM1 also emit light (B12). Accordingly, it can be detected that a short circuit has occurred between the light-emitting elements of the first horizontal line Row 1 in the first light-emitting region LM1 and the second light-emitting region LM2.

Referring to FIGS. 20 and 22 together, in the case of horizontal line-by-line comparison, in FIG. 20, the third horizontal line Row 3, in which the light emission pattern appears, is located close to the second horizontal line Row 2, in which the short circuit has occurred, and thus the short circuit may be relatively less easily identified. In contrast, in FIG. 22, it may be seen that the seventh horizontal line Row 7, in which the light emission pattern appears, is far from the first horizontal line Row 1, in which the short circuit has occurred, and thus the short circuit can be relatively more easily identified. Accordingly, in detecting defects, it may be effective to set a large difference in the driving orders of the horizontal lines between the first light-emitting region and the second light-emitting region. For example, when the first horizontal line in the first light-emitting region LM1 is driven, it may be more efficient to drive the seventh horizontal line, which is relatively far from the first horizontal line, in the second light-emitting region LM2, rather than driving the second horizontal line adjacent to the first horizontal line. In addition, when a voltage level applied to the horizontal line to be detected is set higher than a display driving voltage (or a pixel driving voltage), luminance may increase, making defects more easily visible

Referring to FIG. 17, during inspection for each horizontal line, the lines between which a short circuit has occurred may have a change in current consumption due to a relatively larger number of light-emitting elements being turned on. Accordingly, it is also possible to detect the presence of a short circuit by inspecting the current consumption of each horizontal line through an inspection line DL. For example, a short circuit may be determined when the current consumption measured for each horizontal line deviates from a predetermined reference value. The predetermined reference value may be a value written in a memory or an average value of the current consumption for each horizontal line, but the embodiments of the present specification are not limited thereto.

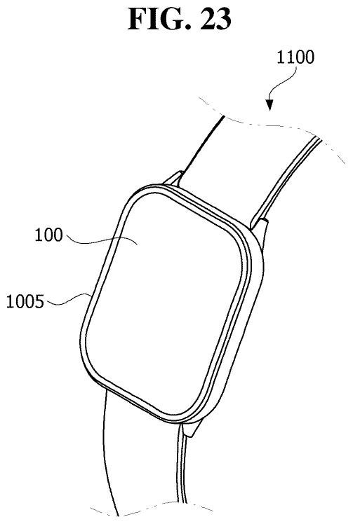

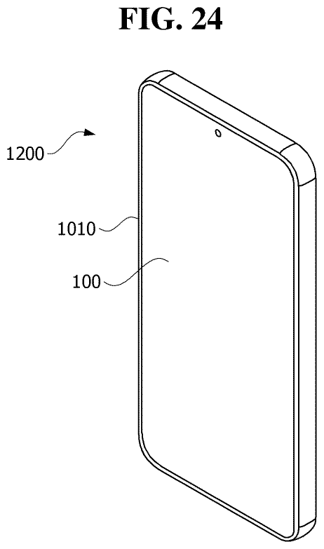

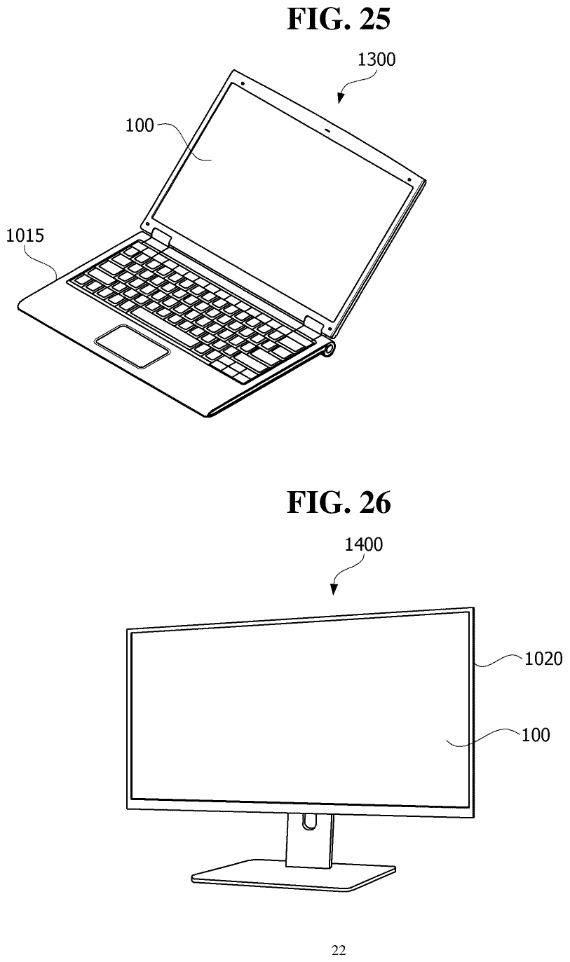

FIGS. 23 to 26 are views illustrating devices to which the display device according to the embodiments of the present specification is applied.

Referring to FIGS. 23 to 26, the display device 1000 according to the embodiments of the present specification may be included in various devices or electronic devices. The various electronic devices may include a wearable device 1100, a mobile device 1200, a laptop computer 1300, and a monitor or TV 1400, but the embodiments of the present specification are not limited thereto.

The wearable device 1100, the mobile device 1200, the laptop computer 1300, and the monitor or TV 1400 may include case parts 1005, 1010, 1015, and 1020, respectively, and may each include the display panel 100 and the display device 1000 according to the embodiments of the present specification described with reference to FIGS. 1 to 15.

For example, the display device according to the embodiment of the present specification may be applied to mobile devices, video phones, smart watches, watch phones, wearable devices, foldable devices, rollable devices, bendable devices, flexible devices, curved devices, sliding devices, variable devices, electronic organizers, e-books, portable multimedia players (PMPs), personal digital assistants (PDAs), MP3 players, mobile medical devices, desktop personal computers (PCs)s, laptop PCs, netbook computers, workstations, navigation devices, vehicle display devices, theater display devices, televisions, wallpaper devices, signage devices, gaming devices, laptops, monitors, cameras, camcorders, household appliances, and the like.

The display device and the defect inspection method according to one or more embodiments of the present specification may be described as follows.

A display device according to one or more embodiments of the present specification may include a substrate including a plurality of first light-emitting regions and a plurality of second light-emitting regions in which a plurality of inorganic light-emitting elements are disposed, a first pixel driving circuit disposed in each of the plurality of first light-emitting regions, and a second pixel driving circuit disposed in each of the plurality of second light-emitting regions. A driving order of horizontal lines in the first light-emitting regions may be different from a driving order of horizontal lines in the second light-emitting regions.

According to one or more embodiments of the present specification, the horizontal line in the first light-emitting region and the horizontal line in the second light-emitting region, which correspond to the same line number, are driven in different horizontal periods.

According to one or more embodiments of the present specification, each of the plurality of first light-emitting regions may have the same driving order of the horizontal lines, and each of the plurality of second light-emitting regions has the same driving order of the horizontal lines.

According to one or more embodiments of the present specification, the first pixel driving circuit may drive a plurality of inorganic light-emitting elements disposed in the first light-emitting region on a horizontal line basis.

According to one or more embodiments of the present specification, the second pixel driving circuit may drive a plurality of inorganic light-emitting elements disposed in the second light-emitting region on the horizontal line basis.

According to one or more embodiments of the present specification, the first pixel driving circuit and the second pixel driving circuit may sequentially drive the plurality of inorganic light-emitting elements disposed along the horizontal lines.

According to one or more embodiments of the present specification, each of the first light-emitting region and the second light-emitting region may include a plurality of first electrodes connected to the inorganic light-emitting elements disposed along the vertical lines among the plurality of inorganic light-emitting elements, and a plurality of second electrodes connected to the inorganic light-emitting elements disposed along the horizontal lines among the plurality of inorganic light-emitting elements.

According to one or more embodiments of the present specification, each of the first pixel driving circuit and the second pixel driving circuit may apply a second voltage to the second electrodes according to the driving order of the horizontal lines, and sequentially apply a first voltage to the plurality of first electrodes for each of the vertical lines.

According to one or more embodiments of the present specification, each of the first pixel driving circuit and the second pixel driving circuit may include a driving transistor configured to apply a first voltage to the inorganic light-emitting elements disposed along the vertical lines, and a switching element configured to apply a second voltage to the inorganic light-emitting elements disposed along the horizontal lines.

According to one or more embodiments of the present specification, the switching element may include a first switching transistor configured to apply the second voltage to the inorganic light-emitting elements disposed along the horizontal lines, and a second switching transistor configured to apply a third voltage, which is different from the second voltage, to the inorganic light-emitting elements disposed along the horizontal lines. The switching element selectively may apply the second voltage or the third voltage to the inorganic light-emitting elements disposed along the horizontal lines.

According to one or more embodiments of the present specification, the second electrodes of the first light-emitting region may be separated from the second electrodes of the second light-emitting region.

According to one or more embodiments of the present specification, the display device may include a plurality of insulating layers disposed on the substrate, a plurality of connection lines disposed on the plurality of insulating layers, and a plurality of banks disposed on the plurality of connection lines. The display device may include a plurality of first electrodes disposed on the plurality of banks, and a second electrode commonly disposed on a plurality of inorganic light-emitting elements disposed along the horizontal line among the plurality of inorganic light-emitting elements.

According to one or more embodiments of the present specification, the first pixel driving circuit and the second pixel driving circuit may be disposed between the plurality of insulating layers and may be electrically connected to the plurality of connection lines.

According to one or more embodiments of the present specification, the inorganic light-emitting elements may be electrically connected to the first electrodes by eutectic bonding.

According to one or more embodiments of the present specification, each of the inorganic light-emitting elements may have a vertical structure including an anode, a light-emitting structure disposed on the anode, and a cathode disposed on the light-emitting structure.

According to one or more embodiments of the present specification, each of the first pixel driving circuit and the second pixel driving circuit may be a driving driver includes a plurality of transistors.

A defect inspection method according to one or more embodiments of the present specification may include preparing a display device including a plurality of first light-emitting regions and a plurality of second light-emitting regions in which a plurality of inorganic light-emitting elements are disposed, and driving horizontal lines of the first light-emitting regions and horizontal lines of the second light-emitting regions in different driving orders. The defect inspection method may further include inspecting whether inorganic light-emitting elements in the horizontal lines other than the driven horizontal line emit light, in the first light-emitting regions and the second light-emitting regions.

According to one or more embodiments of the present specification, in the inspecting, when the inorganic light-emitting elements of the horizontal lines other than the driven horizontal line emit light, the corresponding horizontal lines may be determined to have a short circuit.

According to one or more embodiments of the present specification, a voltage higher than an operation voltage applied during display operation may be applied to the driven horizontal line.

According to one or more embodiments of the present specification, a short circuit may be determined to have occurred when current consumption measured for each of the horizontal lines deviates from a predetermined reference value.

According to one or more embodiments of the present specification, the driving orders may be adjusted such that the horizontal line in the first light-emitting region and the horizontal line in the second light-emitting region, which correspond to the same line number, are driven in different horizontal periods.

According to the present specification, a flicker phenomenon in a display device using inorganic light-emitting elements can be improved

According to the present specification, low-power driving can be achieved using inorganic light-emitting elements.

According to the present specification, defects due to a short circuit between electrodes can be detected.

The effects of the present specification are not limited to the effects mentioned above, and other effects not mentioned can be clearly understood by those skilled in the art to which the technical idea of the present specification pertains from the following description.

Since the content of the present invention described in the summary of the invention and the detailed description of exemplary embodiments does not specify essential features of the claims, the scope of the claims is not limited to matters described in the content of the disclosure.

While the embodiments of the present invention have been described in detail above with reference to the accompanying drawings, the present invention is not necessarily limited to these embodiments, and various changes and modifications may be made without departing from the technical spirit of the present invention. Accordingly, the embodiments disclosed herein are intended to illustrate and not to limit the technical ideas of the present invention, and the scope of the technical ideas of the present invention is not limited by these embodiments. Accordingly, the above-described embodiments should be understood to be exemplary and not limiting in any aspect. The scope of the present invention should be construed by the appended claims, and all technical ideas within the scope of their equivalents should be construed as being included in the scope of the present invention.

What is claimed is:

1. A display device comprising:
a substrate including a plurality of first light-emitting regions and a plurality of second light-emitting regions in which a plurality of inorganic light-emitting elements are disposed;
a first pixel driving circuit in each of the plurality of first light-emitting regions; and
a second pixel driving circuit in each of the plurality of second light-emitting regions,
wherein a driving order of horizontal lines in the plurality of first light-emitting regions is different from a driving order of horizontal lines in the plurality of second light-emitting regions.

2. The display device of claim 1, wherein a horizontal line in a first light-emitting region from the plurality of first light-emitting regions and a horizontal line in a second light-emitting region from the plurality of second light-emitting regions, which correspond to a same line number, are driven in different horizontal periods.

3. The display device of claim 1, wherein each of the plurality of first light-emitting regions has a same driving order of the horizontal lines and each of the plurality of second light-emitting regions has a same driving order of the horizontal lines.

4. The display device of claim 1, wherein the first pixel driving circuit drives a plurality of inorganic light-emitting elements in a first light-emitting region from the plurality of first light-emitting regions on a horizontal line basis and the second pixel driving circuit drives a plurality of inorganic light-emitting elements in a second light-emitting region from the plurality of second light-emitting regions on a horizontal line basis.

5. The display device of claim 4, wherein the first pixel driving circuit and the second pixel driving circuit sequentially drive the plurality of inorganic light-emitting elements disposed along the horizontal lines.

6. The display device of claim 4, wherein each of the first light-emitting region and the second light-emitting region includes:
a plurality of first electrodes connected to inorganic light-emitting elements disposed along vertical lines among the plurality of inorganic light-emitting elements; and
a plurality of second electrodes connected to inorganic light-emitting elements disposed along the horizontal lines among the plurality of inorganic light-emitting elements.

7. The display device of claim 6, wherein each of the first pixel driving circuit and the second pixel driving circuit applies a second voltage to the plurality of second electrodes according to the driving order of the horizontal lines and sequentially applies a first voltage to the plurality of first electrodes for each of the vertical lines.

8. The display device of claim 6, wherein each of the first pixel driving circuit and the second pixel driving circuit includes:
a driving transistor configured to apply a first voltage to the inorganic light-emitting elements disposed along the vertical lines; and
a switching element configured to apply a second voltage to the inorganic light-emitting elements disposed along the horizontal lines.

9. The display device of claim 8, wherein the switching element includes:
a first switching transistor configured to apply the second voltage to the inorganic light-emitting elements disposed along the horizontal lines; and
a second switching transistor configured to apply a third voltage that is different from the second voltage to the inorganic light-emitting elements disposed along the horizontal lines,
wherein the switching element selectively applies the second voltage or the third voltage to the inorganic light-emitting elements disposed along the horizontal lines.

10. The display device of claim 6, wherein the plurality of second electrodes of the first light-emitting region are separated from the plurality of second electrodes of the second light-emitting region.

11. The display device of claim 1, comprising
a plurality of insulating layers on the substrate;
a plurality of connection lines on the plurality of insulating layers;
a plurality of banks on the plurality of connection lines;
a plurality of first electrodes on the plurality of banks; and
a second electrode commonly disposed on a plurality of inorganic light-emitting elements disposed along a horizontal line among the plurality of inorganic light-emitting elements.

12. The display device of claim 11, wherein the first pixel driving circuit and the second pixel driving circuit are between the plurality of insulating layers and are electrically connected to the plurality of connection lines.

13. The display device of claim 11, wherein the plurality of inorganic light-emitting elements are electrically connected to the plurality of first electrodes.

14. The display device of claim 11, wherein each of the plurality of inorganic light-emitting elements has a vertical structure including an anode, a light-emitting structure on the anode, and a cathode on the light-emitting structure.

15. The display device of claim 1, wherein each of the first pixel driving circuit and the second pixel driving circuit is a driving driver including a plurality of transistors.

16. A defect inspection method comprising:
preparing a display device including a plurality of first light-emitting regions and a plurality of second light-emitting regions in which a plurality of inorganic light-emitting elements are disposed;
driving horizontal lines of the plurality of first light-emitting regions and horizontal lines of the plurality of second light-emitting regions in different driving orders; and
inspecting whether inorganic light-emitting elements from the plurality of inorganic light-emitting elements that are in the horizontal lines other than the driven horizontal lines emit light, in the plurality of first light-emitting regions and the plurality of second light-emitting regions.

17. The defect inspection method of claim 16, wherein, during the inspecting, when the inorganic light-emitting elements of the horizontal lines other than the driven horizontal line emit light, the horizontal lines are determined to have a short circuit.

18. The defect inspection method of claim 16, wherein a voltage higher than an operation voltage applied during display operation is applied to the driven horizontal line.

19. The defect inspection method of claim 16, wherein a short circuit is determined to have occurred when current consumption measured for each of the horizontal lines deviates from a predetermined reference value.

20. The defect inspection method of claim 16, wherein the different driving orders are adjusted such that a horizontal line in a first light-emitting region from the plurality of first light-emitting regions and a horizontal line in a second light-emitting region from the plurality of second light-emitting regions, which correspond to a same line number, are driven in different horizontal periods.
